(19) United States
(12) Patent Application Publication
(10) Pub. No.: US 2021/0277547 A1
(43) Pub. Date: Sep. 9, 2021

(54) METHODS OF ASYMMETRICALLY WEAVING RAW FIBER MATERIALS TO CREATE FIBER REINFORCED PRODUCTS AND PRODUCTS CREATED THEREBY

(71) Applicant: Epoch Sports, LLC, Roseville, MN (US)

(72) Inventors: Robert Timothy Pearson, St. Paul, MN (US); James Miceli, Roseville, MN (US)

(21) Appl. No.: 16/808,714

(22) Filed: Mar. 4, 2020

(51) Int. Cl. D03D 11/00; B32B 5/02; B32B 5/26

(52) U.S. Cl. CPC D03D 11/00; B32B 5/024; B32B 5/26; D03D 2700/0111; B32B 2262/106; D10B 2331/021; D10B 2101/06; B32B 2262/101; B32B 2262/0269; D10B 2101/12

(57) ABSTRACT

A fiber reinforced product includes a single ply composite weave made up of individual weaves interconnected together and then processed in a known manner. The individual weaves are made of one of a plurality of possible fiber reinforced materials such as carbon, Aramid or glass. Their fibers are angulated with respect to the axis of elongation of the composite weave in some cases and in other cases the respective lengths of the individual weaves are chosen to accomplish differences in stiffness and flexibility based upon the desired performance properties of the finished product in which the single ply composite weave is incorporated.

### BACKGROUND OF THE INVENTION

The present invention relates to methods of asymmetrically weaving raw fiber materials to create fiber reinforced products and products created thereby.

In the prior art, it is well known to use fiber reinforcement to reinforce various products. In one prominent example, the concept of “prepreg” is employed which consists of use of a reinforced woven fabric or unidirectional tape which has been pre-impregnated with a resin system. The resin system already includes the proper curing agent. As a result, the prepreg is ready to be placed into a mold without additional resin added and a process for curing the product is undertaken.

Typically, in the prior art, when fiber reinforcement is employed, it is employed linearly. Thus, for example, in the case of an elongated shaft, the fiber reinforcement typically extends along the axis of elongation of the shaft with the fibers parallel to that axis of elongation. In such products, when it is desired to increase the strength and/or stiffness in differing areas, the number of layers of fibrous mats is increased and when it is desired to have certain areas weaker and/or less stiff, the number of layers is reduced. Other techniques can involve varying the thicknesses or diameters of the fibers themselves or varying the spacing between adjacent fibers. Sometimes, prior art fiber reinforcement includes fibers oriented at angles to the axis of elongation of the mat being employed. However, typically, such orientations are found in multi-layer plies and the angulation of the fibers is in an entire layer. The present invention differs from this configuration in that the present invention contemplates only a single layer composite weave in which regions within the weave are composed of differing materials, lengths, and angulations to achieve differing properties for the finished product.

Given the various ways by which strength is varied in a product along its length, as described above, serious problems arise concerning the consistency of the finished product itself. By requiring variations in the number of mats, variations in thicknesses of mats and fibers, variations in spacing between adjacent fibers, these variations result in differing weight per unit length of the product. This causes imbalances that might need to be addressed through introduction of weights or other items to balance out the product.

FIG. 1 shows a basic process by which prepreg is created. Aligned fibers are impregnated with epoxy resin to create a prepreg product that may easily be inserted in a mold to create a finished product.

FIG. 2 shows a variety of types of prepreg made up of woven fabrics as opposed to merely parallel fibers. As seen in FIG. 2, these weaves include but are not limited to plain weaves in variations including directional and uniform, basket weaves, variations of twill weaves and harness satin weaves. Any of these weaves may be used in accordance with the teachings of the present invention but in unique ways. Each such weave is chosen based upon its properties of strength, stiffness, flexibility, and ability to be made out of various materials.

In the prior art, fibers typically used in these weave patterns are carbon, graphite, E-glass, S-glass, and Aramid also known as KEVLAR® fiber. KEVLAR® is a registered trademark of Dupont. Of course, other materials may be employed. The weave patterns shown in FIG. 2 repeat over and over again to create a fibrous mat which may be employed as desired.

Prior art weave technology exhibits repeating patterns, consistent stiffness, durability, and flexibility. The prior art fails to contemplate variations in materials, angulation, and other characteristics over short distances.

### SUMMARY OF THE INVENTION

The present invention relates to methods of asymmetrically weaving uncured prepreg fiber materials to create fiber reinforced products and the products created thereby. The present invention includes the following interrelated objects, aspects and features:

(1) The main intention of the present invention is to create stiffness zones, zones of decreased stiffness, added durability, enhanced “feel” while maintaining constant wall thickness and uniformity in finished products. The present invention creates a method to make discontinuous, non-repeating, asymmetrical pattern composite weaves of a variety of prepreg reinforced materials such as, for example, fibers of carbon, glass, and Aramid also known as KEVLAR®. The prepreg aspect is created through use of epoxy substances or other thermoset/thermoplastic matrices. The inventive composite weaves can be employed on the outside of, inside of, or between layers of reinforced unidirectional prepreg fibrous materials oriented in various angles and thicknesses, positioned within the structure that is processed to create a finished product.

(2) The present invention has great benefits to the manufacturing process for fiber reinforced products. First, it provides finished products with consistent cross-sectional wall thickness. This reduces the potential for a stress riser to be formed or a concentrated location where a failure could occur due to changes in wall thickness that cause points of weakness. Second, due to the unique structure of the composite weaves of the present invention, angles and fiber orientations are transitioned in a manner that minimizes potential stress risers as a result of creation of a composite weave with each ply connected by a weaving method that may include weaving a ply over and under elongated prepreg ribbons. Third, weave components forming a composite weave can be made of various types of materials, grades of materials, and angulations of materials all in a single layer. Fourth, the present invention facilitates customizing the specifications of a finished product by permitting rapid changes in characteristics over a short length.

(3) In comparison with the prior art, each composite weave is individually built using a jig to weave each woven piece into the composite weave. Then this combination of woven pieces is cut to the desired shape to create the composite weave. This is as compared to traditional weaves which are made using a loom or weaving machine because traditional weaves only contemplate repeating patterns that can be done mechanically. The present invention is best carried out by determining the desired characteristics of the finished product and then manually assembling weave pieces to create a composite weave.

(4) The present invention recognizes that prior art fiber reinforced products are typically made with fibers running parallel or angled to the axis of elongation of the product and variations in stiffness being accomplished by varying the thickness of fibers, their spacing with respect to one another, and the number of layers of fiber weaves employed at various regions of the product. The present invention improves upon the prior art by dramatically altering the manner by which fibers are laid up and included in a finished product.

(5) In particular, the present invention contemplates utilizing not only prepreg with parallel fibers but additionally a variety of weaves and in which variations in stiffness are accomplished without needing to vary thickness and spacing of fibers or the number of layers of plies employed.

(6) In accordance with the teachings of the present invention, a product is designed with desired areas of greater and lesser stiffness. Such a product is manufactured by varying the angulation of fibers within plies employed, with greater stiffness occurring when fibers run parallel to the axis of elongation of the product and with stiffness being reduced when the angulation between fibers and the axis of elongation of the product get larger and larger. Variations in length of fibers in woven mat pieces can also achieve the same effect.

(7) Different mats made in accordance with the teachings shown in FIGS. 1 and 2 are woven together to create a large, typically elongated, composite mat made up of various ones of these weaves or parallel fiber mats with variations in angulation with respect to the axis of elongation of the finished product and/or length of fibers being incorporated into this composite weave so that the various areas of the product where greater and lesser stiffnesses are desired are created.

(8) The composite weave needs only to be of a single woven layer to accomplish variations in stiffness along the length of the proposed finished product. Additionally, the dimensions of each mat that is included in a composite weave are varied to vary, for example, the length of an area where stiffness is enhanced or reduced. Thus, for example, a mat may be one inch in length with fibers parallel to the axis of elongation of the product, thereby providing enhanced stiffness in that region. The next mat woven to the first-mentioned mat in the composite mat may be two inches in length with its fibers angled at, for example, a 45° angle with respect to the axis of elongation of the proposed finished product. Thus, for the length of that second-mentioned mat, stiffness is reduced.

(9) With these concepts in mind it is possible to create a finished product that varies the stiffness along its length while at the same time maintaining a substantially uniform weight per unit length so that a product can be made well-balanced.

(10) A main emphasis of the present invention is use in association with manufacture of lacrosse stick handles. In such handles, it is advantageous to provide areas of reduced stiffness to provide the handle with “whip” so that when a player is shooting a lacrosse ball, that whip action enhances the speed of a lacrosse ball as shot out of the head of the lacrosse stick.

(11) Other possible applications of the present invention include use in association with ice and roller hockey sticks, field hockey sticks, cricket sticks, fishing rods, snow boards, various tools such as the handles of hammers, axes, shovels or other tools, bicycle components, pole vaulting poles, skis and ski poles, paddles to paddle vessels, surf boards, parts for motocross and off road vehicles, protection items, badminton rackets, wind power blades, wind surfing components, various components for boats, various components for automobiles, prosthetics, and various poles and shafts, slats and beams, hang gliding wing spars, kites, aviation, fitness and strength training devices, pole vaulting poles, and many others.

(12) Pieces of fabric including woven fabrics like those of FIG. 2, unidirectional fiber fabrics like that which is shown in FIG. 1 are provided in various materials, lengths, sizes, angles, and shapes and are woven together. These pieces are woven asymmetrically so that the variations in materials, angle, length, and size result in a finished product with variations in stiffness. This results in highly customizable shaft structures with constant wall thicknesses.

(13) A custom loom may be provided known as a jig loom which allows weaving together of numerous diverse woven pieces to create a single non-repeating pattern elongated composite woven piece used to create the finished product. The finished composite asymmetrical weave can be used on the outside surface of a part, the inside surface of a part, or otherwise buried within the part between its inside and outside surfaces to achieve desired performance properties.

(14) A partial list of fibers that can be woven or made into unidirectional fiber non-repeating pattern weave, usable in accordance with the teachings of the present invention, include the following: Aramid fibers such as KEVLAR® 29, 49 and 149; graphite/carbon fibers including AS4, AS4C, IM4, IM6, IM7, IM8, IM9, T300, M40J, M60J, and KI3D2U, as examples; glass including E-glass and S-glass; polyethylene including spectra 900 and spectra 1000; silicon carbide fibers such as those known as monofilament and Nicalon; aluminum oxide (Al₂O₃) ceramic fiber, including fiber FP, and Nextel 610; organic fibers including bamboo, hemp, ramie, and mud silk.

As such, it is a first object of the present invention to provide methods of asymmetrically weaving prepreg fiber materials to create fiber reinforced products and the products created thereby.

It is a further object of the present invention to provide such a method and finished products in which a composite weave used to create such products is made up of a plurality of differing woven pieces woven together in differing configurations.

It is a further object of the present invention to provide such a method and finished products in which the finished products may be made with varying degrees of stiffness and non-stiffness along a linear length by varying angulation of woven pieces woven into the composite weave.

It is a still further object of the present invention to provide such a method which produces a weave of a single thickness along its length as opposed to multiple thickness weaves and plies found in the prior art.

It is a still further object of the present invention to provide such a method in which the composite weave includes woven pieces made up of a variety of differing materials, lengths, shapes woven together into the composite weave for the purposes of the present invention.

It is a yet further object of the present invention to provide products which require variations in stiffness and flexibility along their lengths for advantageous use while maintaining a relatively consistent weight per unit length.

These and other objects, aspects and features of the present invention will be better understood from the following detailed description of the preferred embodiments when read in conjunction with the appended drawing figures.

### BRIEF DESCRIPTION OF THE DRAWINGS

FIG. 1 shows a schematic representation of creation of a prepreg material made up of parallel fibers and traditional woven fabric embedded with resin and including an appropriate curing agent.

FIG. 2 shows examples of typical repeating pattern weaving patterns for weaving fibers for use in making various products.

FIG. 3 shows views of a prior art lay up of mats, repeating pattern weave (bottom) and a lay up of mats, non-repeating pattern weave in accordance with the teachings of the present invention (top).

FIG. 4 shows schematic representations of a manner in which the prior art creates stiffer and less stiff regions on an elongated product which creates a stress riser and weak point.

FIG. 5 shows a schematic representation of the sequence of manufacture of elongated products using fiber reinforced unidirectional materials and weaves.

FIG. 6 shows a top view of a non-repeating pattern weave made up of a plurality of differing weave portions arranged as shown.

FIG. 7 shows a further top view of a weave made up of a plurality of differing weave portions arranged as shown.

FIG. 8 shows a further top view of a weave made up of a plurality of differing weave portions arranged as shown.

FIG. 9 shows a further top view of a weave made up of a plurality of differing weave portions arranged as shown.

FIG. 10 shows a further top view of a weave made up of a plurality of differing weave portions arranged as shown.

FIG. 11 shows a further top view of a weave made up of a plurality of differing weave portions arranged as shown.

FIG. 12 shows a further top view of a weave made up of a plurality of differing weave portions arranged as shown.

FIG. 13 shows a further top view of a weave made up of a plurality of differing weave portions arranged as shown.

FIG. 14 shows a further top view of a weave made up of a plurality of differing weave portions arranged as shown.

FIG. 15 shows a side view of the weave of FIG. 14 showing how the profile smooths out as the hoop plies become smaller and tighter.

FIG. 16 shows a schematic representation of assembly of a weave with weave pieces varied as to their angular relationship with an axis of elongation of an elongated shape.

FIG. 17 shows weave pieces assembled together which are aligned with the axis of elongation of an elongated shape but provide a non-repeating pattern based upon varying the lengths of the weave pieces.

FIG. 18 shows a schematic representation of a weave made up of weave pieces of differing lengths to modify stiffness.

FIG. 19 shows cross-sectional views of examples of products made in accordance with the teachings of the present invention.

FIG. 20 shows cross-sections of products similar to those of FIG. 19 but with honeycomb foam or other material cores with the laminate on the outside.

FIG. 21 shows four parallel carbon prepreg ribbons which will be used in weaving different shaped weave pieces to form a composite elongated weave using the prepreg pieces shown below the ribbons.

FIG. 22 shows a view similar to FIG. 21 with the four prepreg strips placed on the jig.

FIGS. 23-32 show the sequential assembly of the weave pieces interwoven into the four carbon fiber ribbons.

FIG. 33 shows the assembled weave pieces of FIG. 32 but with the edges cut to form a non-repeating composite weave piece.

FIGS. 34-45 show sequential assembly of weave pieces diagonally with respect to an elongated drawing on a flat surface to create a composite elongated weave piece.

FIG. 46 shows the assembly of FIG. 45 but with the edges cut to conform to the outline best shown in FIG. 34 to form a non-repeating composite weave piece.

### SPECIFIC DESCRIPTION OF THE PREFERRED EMBODIMENTS

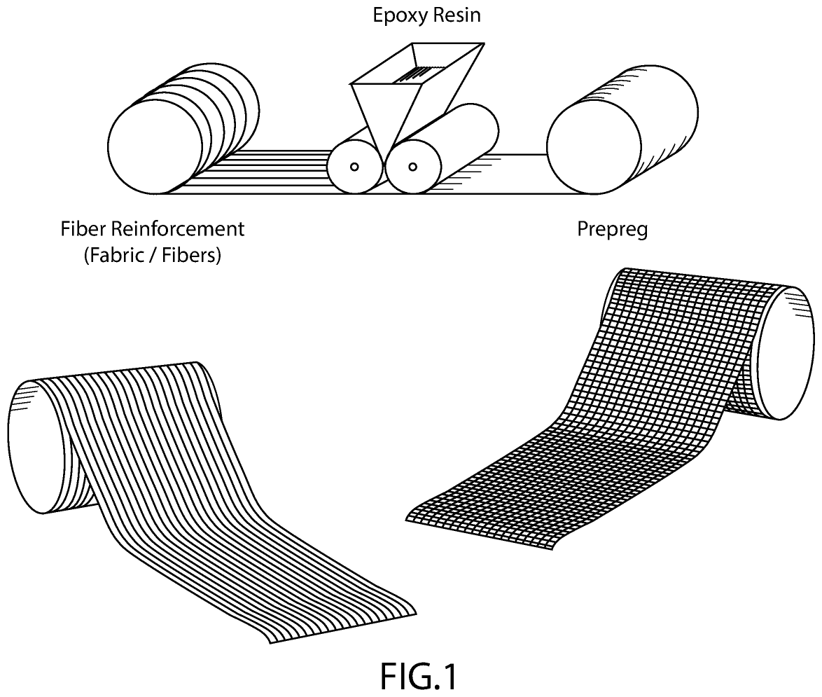

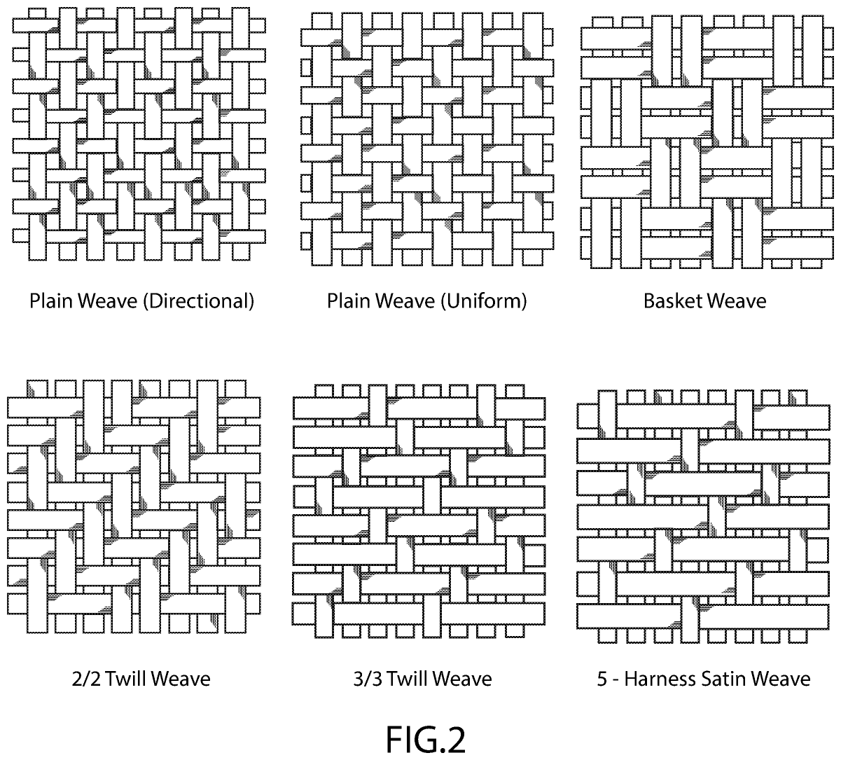

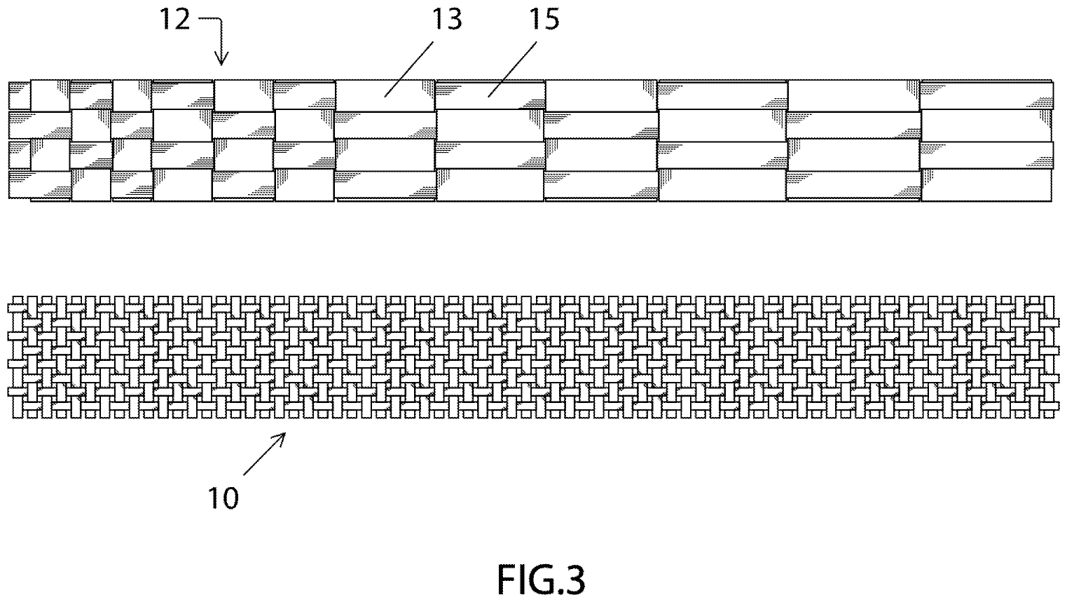

With reference to FIG. 3, a composite weave is generally designated by the reference numeral 10 and is a manner by which such repeating pattern weaves are created in the prior art. Noteworthy is the uniformity of the weave from one end to the other. By contrast, in the same FIG. 3, the weave 12 is made up of plural rectangular woven pieces with one material or fiber angle designated by the reference numeral 13 and another material or fiber angle designated by the reference numeral 15. These materials consist of weaves such as those shown in FIGS. 1 and 2. As shown in the top image of FIG. 3, the shapes of the various woven pieces that are attached together are varied. As the pieces are lengthened in the direction of elongation of the entire piece, stiffness is reduced. Thus, in the left hand side of the top image in FIG. 3, the small square pieces introduce greater stiffness than the much longer pieces at the right side of the view. As shown in that view, as one looks from left to right, the respective lengths of the pieces get gradually longer and longer. This means that a product manufactured using the entire composite weave shown in the top view of FIG. 3 starts out extremely stiff to the left and gets less and less stiff in the direction to the right.

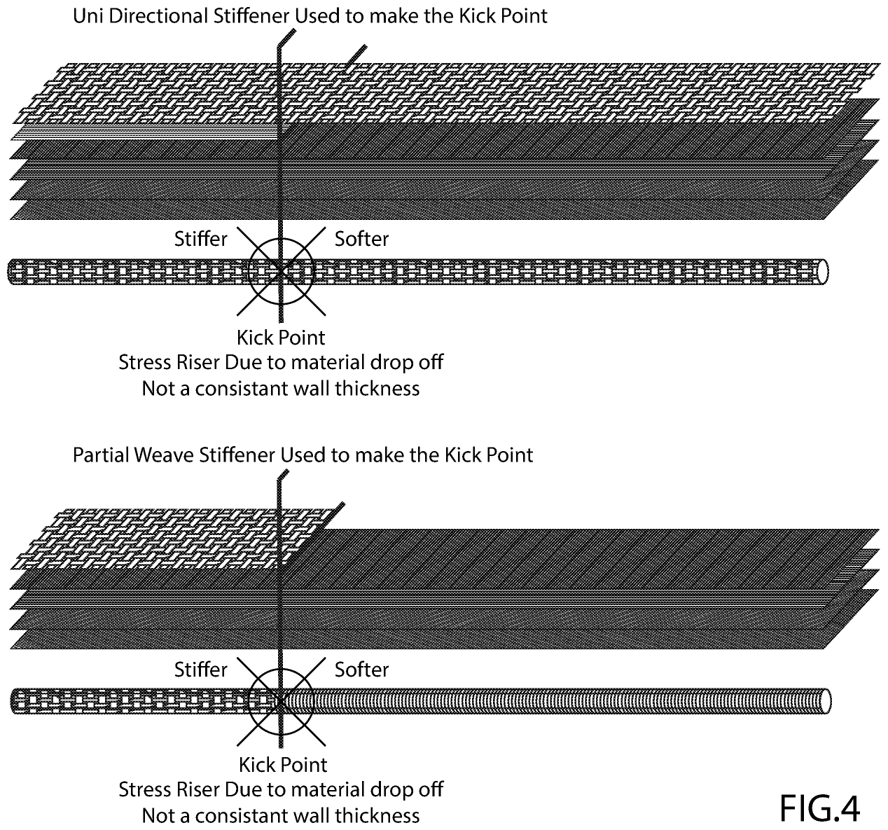

With reference to FIG. 4, prior art techniques are shown which use unidirectional or woven fiber to create stiffer areas of the shaft with a transition point between a stiffer area and a less stiff area. Thus, as seen in both images of FIG. 4, the eventual product is stiffer on the left side and less stiff or softer on the right side. There is a dramatic transition in plies between those portions of the finished product which weakens the product at the transition point and reduces durability.

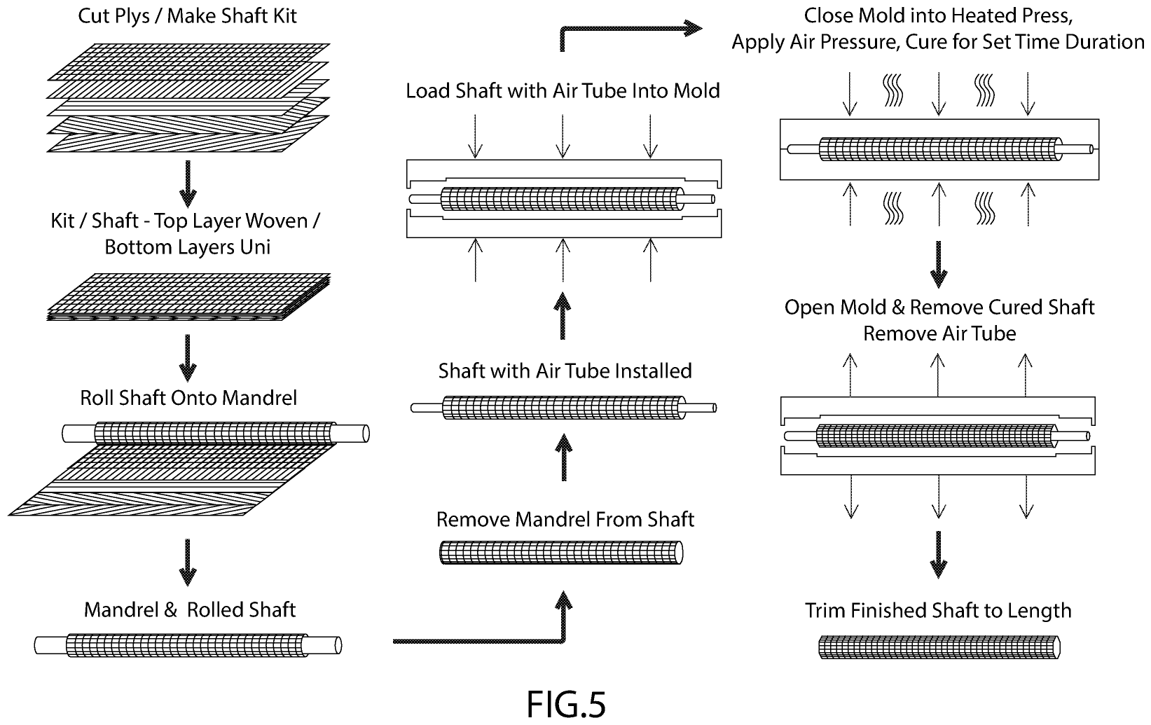

FIG. 5 shows a schematic representation of a method of manufacturing a product using woven pieces. As seen in FIG. 5, a shaft kit is made of cut plies and is arranged to be rolled onto a mandrel. The mandrel is removed and a shaft with an air tube is installed instead, then the air tube and shaft are loaded into a mold and the molding process is completed, whereupon the shaft is trimmed to its desired length. This is a typical process that can be used in accordance with the teachings of the present invention based upon creation of the woven fabric pieces attached together to create a composite weave.

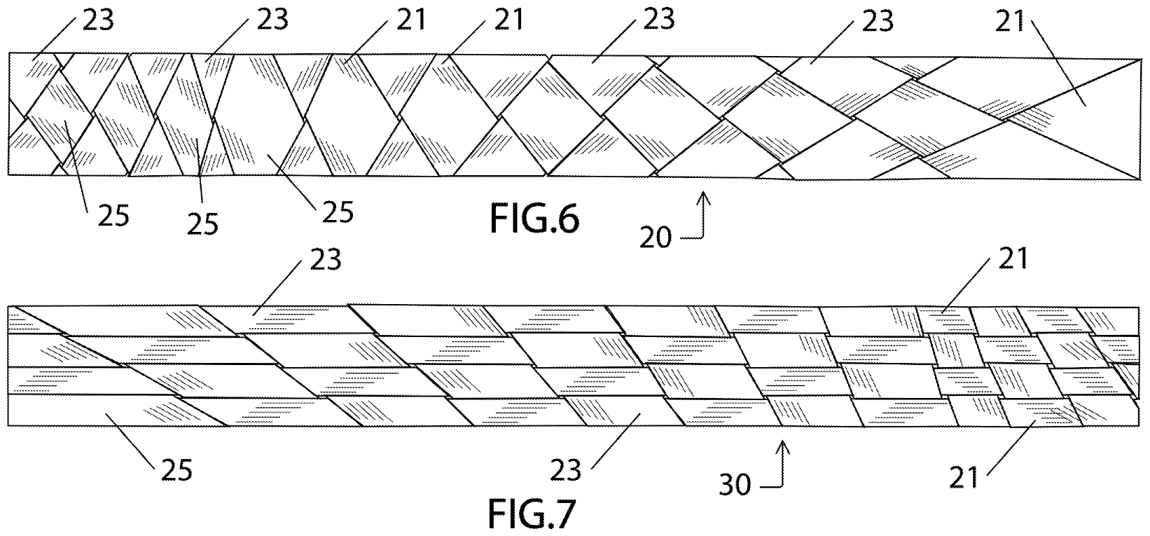

FIGS. 6-14 show a number of varieties of composite woven fabric pieces assembled together to provide various properties. FIG. 6 shows a composite woven piece 20 which includes pieces of E-glass 21, pieces of Carbon A intermediate modulus 23, pieces of Carbon B high modulus 25. Each of these pieces has properties well known to those of ordinary skill in the art. The composite fabric piece of FIG. 6, all the fabric pieces are woven together and connected and present themselves diagonally with respect to the axis of elongation of the entire piece 20. This introduces reduced stiffness and thus, the inherent stiffness of the various materials 21, 23 and 25 also determine the relative stiffness of different regions of the composite fabric piece. E-glass 21 is used because it has high elongation, good for flex and durability. It is shaped as shown in FIG. 6 as one of two plies woven at the same angle in a plus and minus configuration creating a diamond pattern, and additional angle changes make the diamond pattern thinner or wider and change the orientation of the directional fibers. When woven in with the other angles/materials, it makes a non-repeating woven pattern with specific flexural properties while maintaining the same ply thickness. Reference numerals 21 and 23 both refer to carbon fiber but could, if desired, be intermediate, or high modulus carbon with differing stiffness and strength characteristics. This combination can make for stiffer and stronger designs. It is shaped here as one of two plies woven at the same angle in a plus and minus configuration creating a diamond pattern. Additional angle changes make the diamond pattern thinner or wider and change the orientation of the directional fibers. When woven in with the other angles/materials, it makes a non-repeating composite weave with specific flexural properties while maintaining the same ply thickness.

FIG. 7 shows a composite woven piece 30 which is made up of generally rectangular or rhomboid-shaped pieces with pieces including those of Carbon A intermediate modulus 23, pieces of Carbon B high modulus 25, and E-glass 21 as shown. The angular relationship of the fabric pieces and their variety of lengths affect the stiffness of the piece 30 along its length. The shorter pieces in the direction of the longitudinal axis of the piece 30 are relatively stiffer for unit material than the longer pieces. The carbon fiber uni-directional materials can either be the top ply running in zero direction or the bottom ply running at an angle, cut to a unique shape and woven into this pattern to create a constant ply thickness. Its shape as shown controls stiffness, durability, and flex, and is woven into a non-repeating pattern to create specific structural properties.

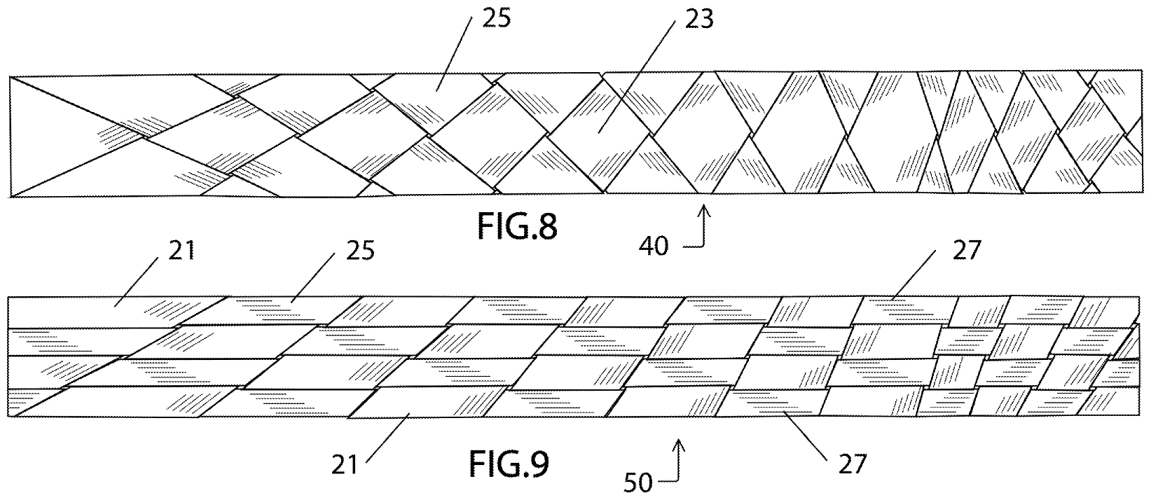

FIG. 8 shows a composite fabric piece 40 which is made up solely of diagonal pieces of Carbon A intermediate modulus 23, and pieces of Carbon B high modulus 25. Again, the diagonal nature of those pieces reduces the relative stiffness in the direction of the axis of elongation of the piece 40. E-glass pieces 21 can be used because they have high elongation, good for flex and durability. They are shaped here as one of two plies woven at the same angle in a plus and minus configuration creating a diamond pattern. Additional angle changes make the diamond pattern thinner or wider and change the orientation of the directional fibers. When woven in with the other angles/materials, they make a non-repeating weave with specific flexural properties and maintain the same ply thickness.

FIG. 9 shows a composite woven piece 50 that includes fabric pieces of E-glass 21, Carbon B high modulus 25, and Carbon C ultra high modulus 27 as shown. Again, the diagonal nature of the pieces reduces their relative stiffness in the direction of elongation of the composite fabric piece 50 and the various properties of the materials of the individual fabric pieces also contribute to the characteristics of the composite fabric piece 50. Carbon fiber runs the length of the pattern and provides a baseline for stiffness and is configured in 4 equal parts running 0 degree orientation. The carbon fiber pieces are angle cut patterns that adjust the stiffness, create stiffness or kick point zones and structurally fine tune the design.

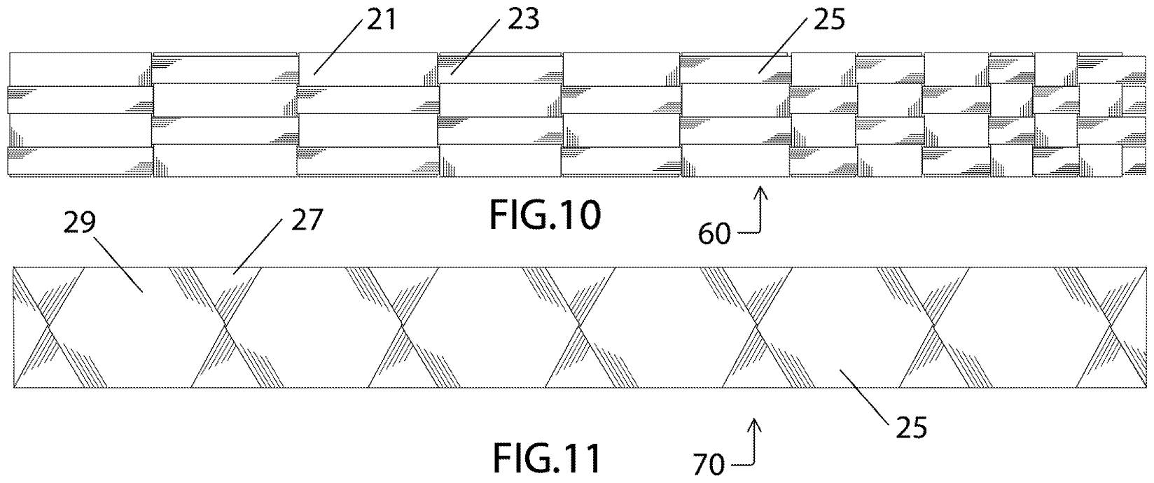

FIG. 10 shows a composite fabric piece 60 made up of a plurality of rectangular pieces of E-glass 21, Carbon A intermediate modulus 23, pieces of Carbon B high modulus 25, and varied as to their lengths along the longitudinal extent of the composite fabric piece 60. Based upon the individual properties of the materials included in the composite fabric piece 60, the relative stiffness thereof is varied along the longitudinal length thereof. The carbon fiber uni-directional material in this figure can either be the top ply running in zero direction or the bottom ply running at an angle, cut to a unique shape and woven into this pattern to create a constant ply thickness. Its shape as shown controls stiffness, durability, and flex, and is woven into a non-repeating pattern to create specific structural properties.

FIG. 11 shows a composite fabric piece 70 which is made up of diagonally disposed pieces of Aramid (KEVLAR® 29), Carbon C ultra high modulus 27, and Carbon B high modulus 25. As explained above, the diagonal nature of the various pieces reduces the stiffness along the longitudinal extent of the composite fabric piece 70. Additionally, the individual properties of the materials 25, 27 and 29 also affects the relative stiffness from one end of the composite fabric piece 70 to the other. Aramid (KEVLAR®) can be used due to impact strength and durability. It is shaped in this figure as one of two plies woven at the same angle in a plus and minus configuration creating a diamond pattern. Additional angle changes make the diamond pattern thinner or wider and change the orientation of the directional fibers. When woven in with the other angles/materials, it makes a non-repeating weave with specific flexural properties and maintains the same ply thickness. Carbon fiber 27, 25 is shaped here as one of two plies woven at the same angle in a plus and minus configuration creating a diamond pattern. Additional angle changes make the diamond pattern thinner or wider and change the orientation of the directional fibers. When woven in with the other angles/materials, it makes a non-repeating weave with specific flexural properties and maintains the same ply thickness.

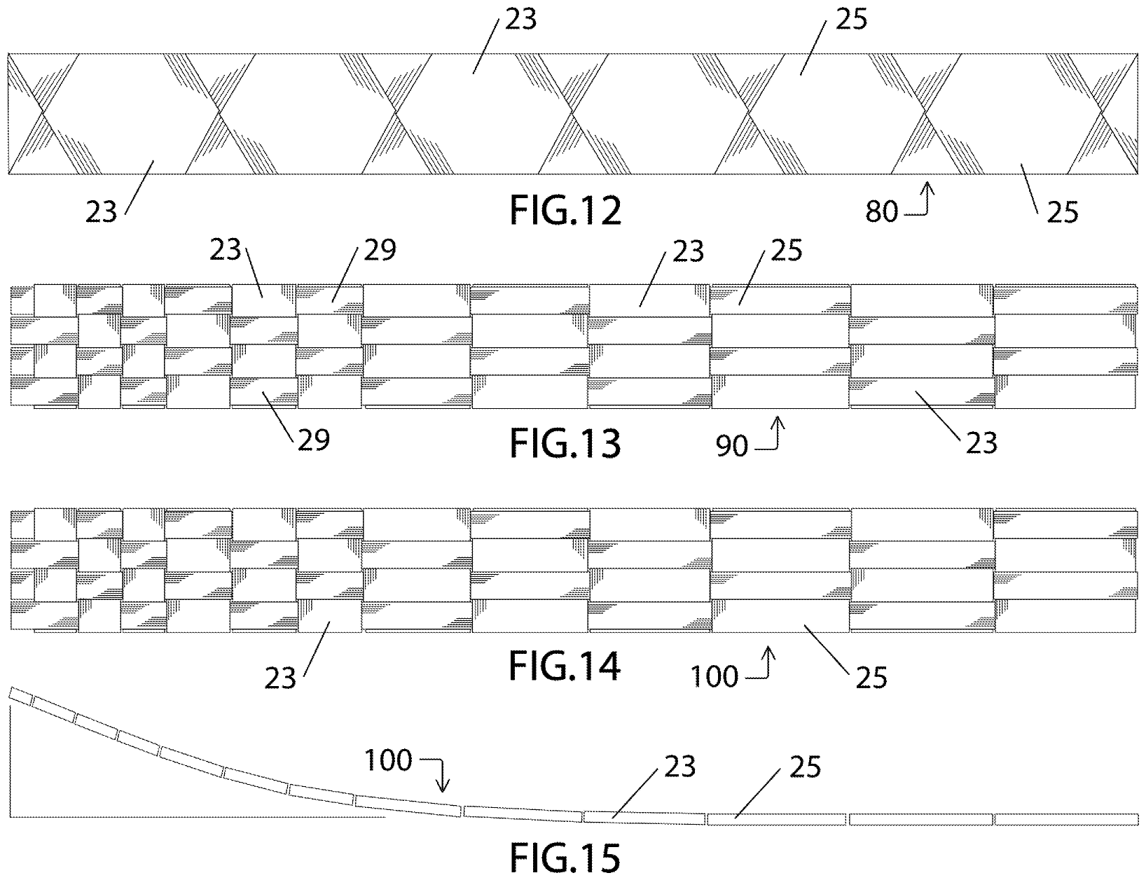

FIG. 12 shows a composite fabric piece 80 made up of diagonally disposed pieces of Carbon A intermediate modulus 23 and Carbon B high modulus 25 as shown. Again, the diagonal nature of the fabric pieces reduces the relative stiffness and the individual properties of Carbon A and Carbon B determine the stiffness of the piece from one end to the other. Carbon fiber has stiffer properties making that part of the design stiffer than other regions. It is oriented into a non-repeating pattern and transitions to E-glass regions to give this design a high flex area.

FIG. 13 shows a composite fabric piece 90 made up of individual pieces of Aramid fiber 29, Carbon A intermediate modulus 23, and Carbon B high modulus 25 as shown. In the composite fabric piece 90, the individual fabric pieces 23, 25 and 29 are rectangular and aligned with the longitudinal axis of the entire composite fabric piece 90. As shown, the lengths of the individual fabric pieces differ from one another with longer fabric pieces resulting in reduced stiffness. As before, the individual properties of the different materials employed also affect the relative stiffness of the entire composite fabric piece 90 from one end to the other. The carbon fiber uni-directional material in FIGS. 12 and 13 can either be the top ply running in zero direction or the bottom ply running at a 90 degree angle. It is cut into different widths to help flex control, and is woven into this pattern to create a constant ply thickness. Its shape as shown controls stiffness, durability, and is woven into a non-repeating pattern to create specific structural properties.

FIG. 14 shows a composite fabric piece 100 that is made up of rectangular pieces of Carbon A intermediate modulus 23 and Carbon B high modulus 25 with the pieces at the left hand side of the Figure being shorter in length than those on the right side. What this means is that the entire composite fabric piece 100 is relatively stiffer to the left and gradually becomes less stiff in the right hand direction.

FIG. 15 shows the composite fabric piece 100 that is bent in the left hand direction.

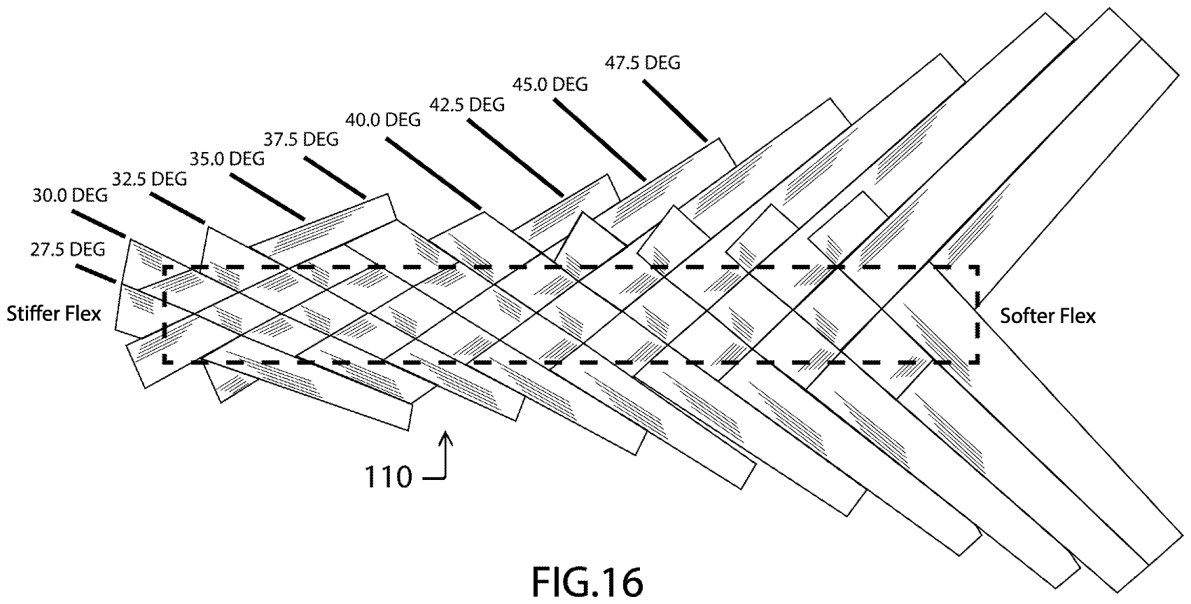

With reference now to FIG. 16, another composite weave is shown designated by the reference numeral 110. As seen, a hatched line 111 shows an elongated rectangle which will comprise the composite weave when the edges of the material are cut away. As seen in FIG. 16, the weave pieces are angled with respect to the axis of elongation of the rectangle 111. The angle of those pieces with respect to the elongation of the rectangle 111 varies from 27.5° at the left hand side to 47.5° at the right hand side. The sharper the angle, the less stiff the finished product will be. Thus, in FIG. 16, the left hand end of the rectangle 111 will be stiffer than the right hand end of the rectangle 111.

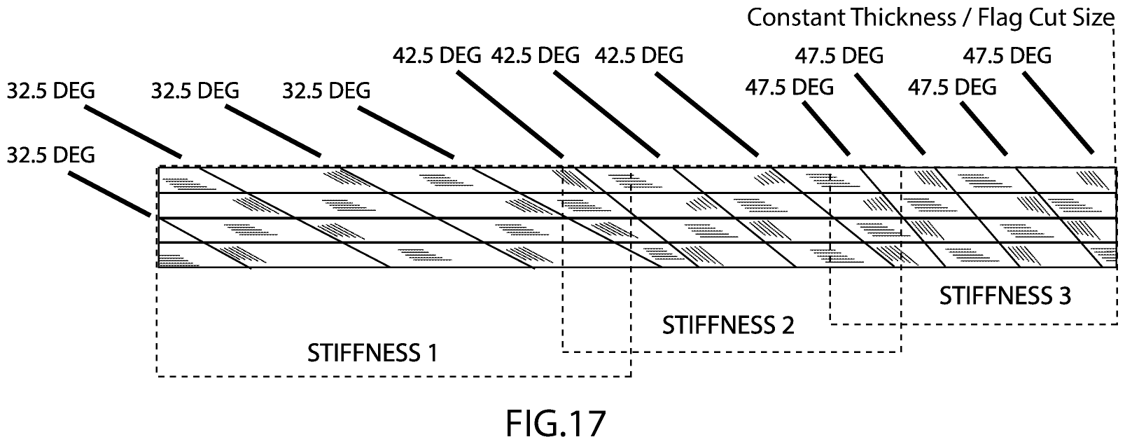

Similarly, with reference to FIG. 17, a composite weave piece 120 is shown and a rectangle 121 is similar to the rectangle 111 of FIG. 16. As shown, the rectangle 121 defines a finished composite weave once the pieces of fabric are cut away so that all that is left is fabric within the rectangle 121. As explained therein, the differing angulation of various ones of the fabric pieces and their differing lengths define three zones of stiffness shown as stiffness 1, stiffness 2, and stiffness 3. The thickness of the composite weave is the same throughout its length, thereby rendering the finished product more uniform in terms of weight per unit distance. In the piece 120, the stiffness is greater on the left hand side than on the right hand side.

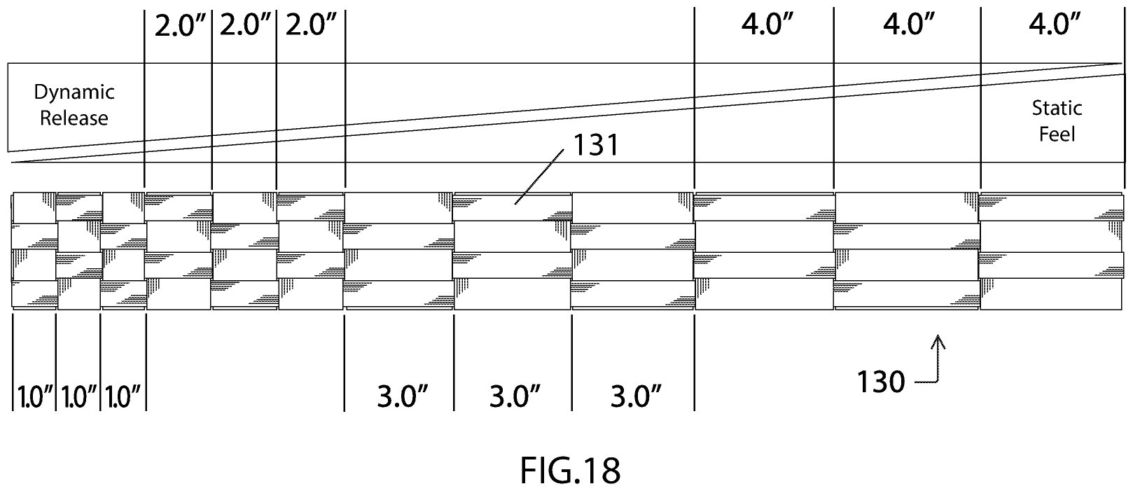

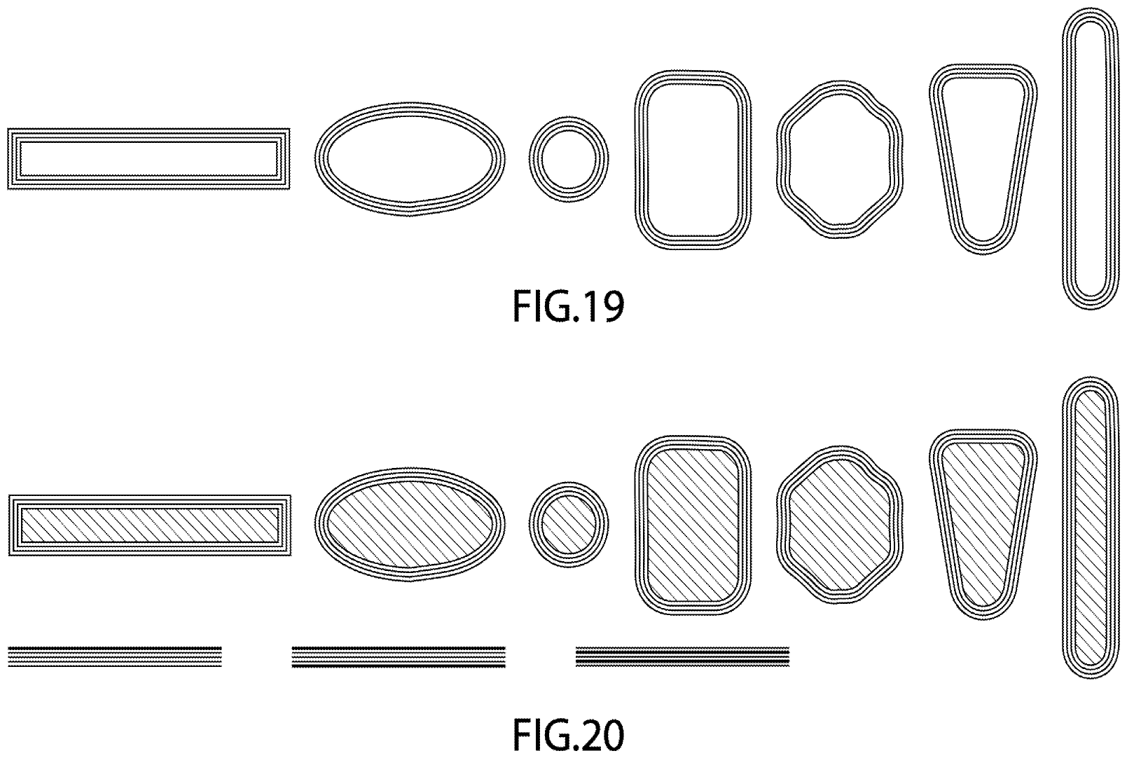

FIG. 18 shows another composite weave piece 130 that includes a plurality of rectangular woven fabric pieces that are all aligned with the longitudinal extent of the rectangular hatched area 131 with the pieces being shorter in length to the left and longer in length to the right. In this embodiment, there is greater stiffness on the left hand side than on the right hand side due to the increasing length of the woven fabric pieces.

FIGS. 19 and 20 show cross-sections of various products that may be made in accordance with the teachings of the present invention. FIG. 19 shows hollow structures while FIG. 20 shows structures that have honeycomb foam or other material cores with laminate surrounding the core. As explained in FIG. 19, products that can be made hollow as shown include bicycle frames, handlebars, forks, swing arms, bats, lacrosse shafts, hockey shafts and blades, golf shafts, field hockey sticks, rackets, poles, and fishing rods. In FIG. 20, the core structures shown therein in cross-section can be used in making such products as surfboards, stand up paddle boards, snow boards, paddles, hockey blades, wind power blades, and others.

Additionally, as explained hereinabove, numerous types of products and components of products may be made in accordance with the teachings of the present invention including such diverse products as lacrosse shafts, field hockey and cricket sticks, snow boards, fishing rods, tool handles, hockey sticks, bicycle components, skis and ski poles, paddles for boating, motocross and OHV parts, tennis racket handles and heads, surfboards, SUP boards, protection products, badminton rackets, wind power blades, baseball bats, wind surfing components, various components of boats and other vessels, automotive components, prosthetic devices, poles and shafts including pole vaulting poles, slaten beams, hang gliding wing spars, kites and other aviation products, and fitness and strength training devices. These categories of products are merely exemplary.

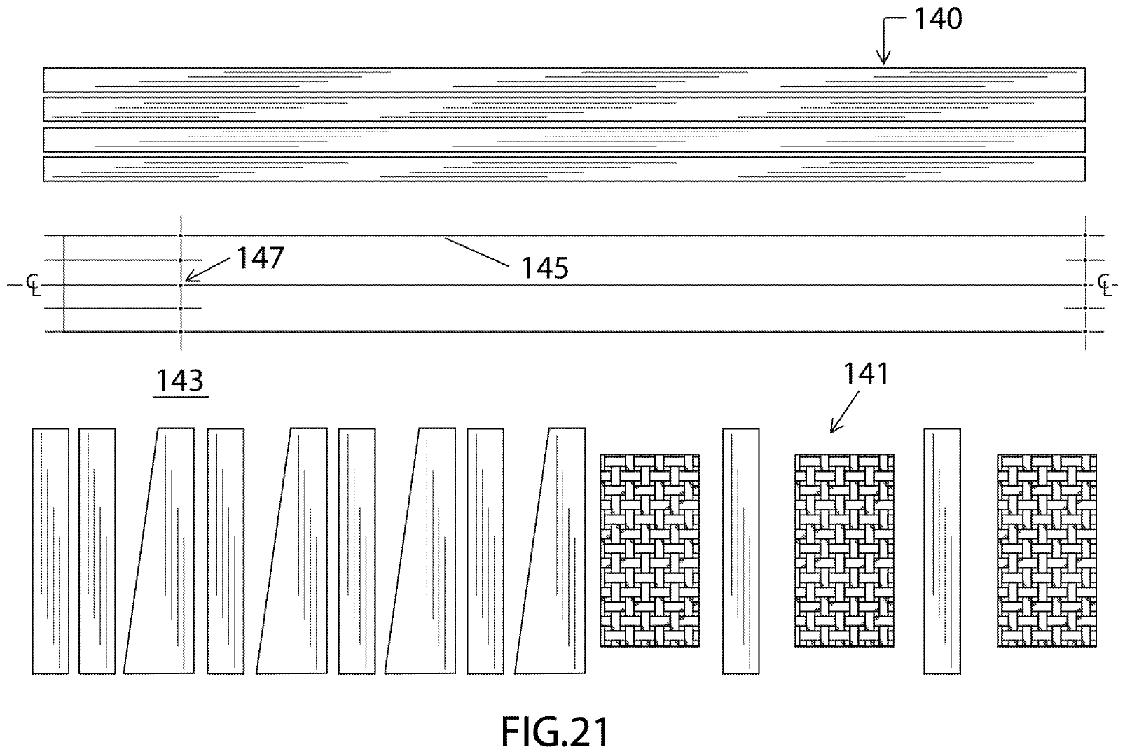

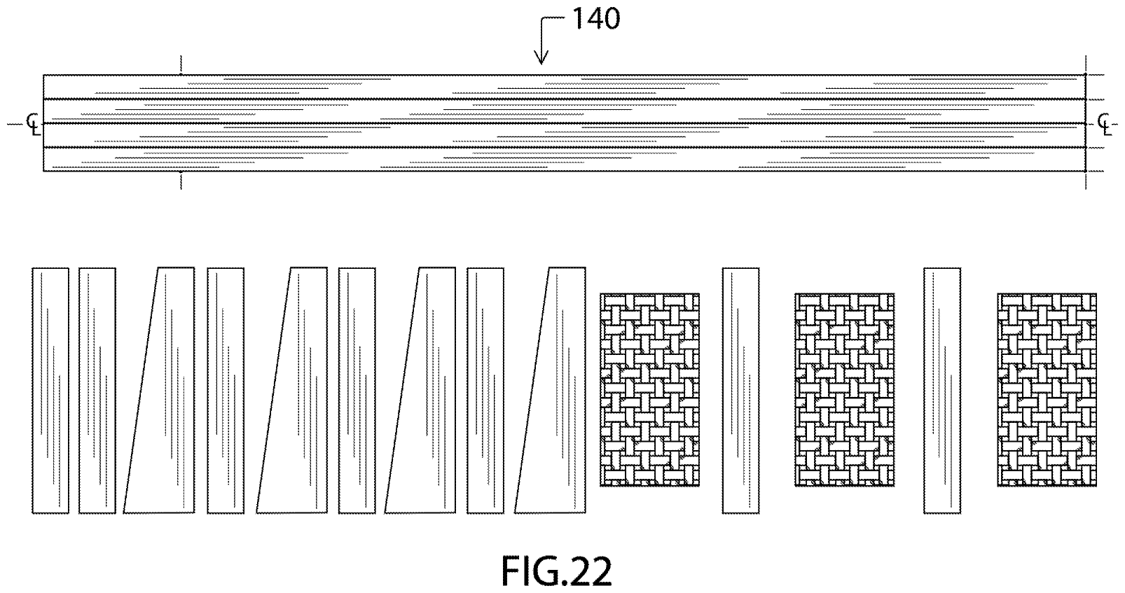

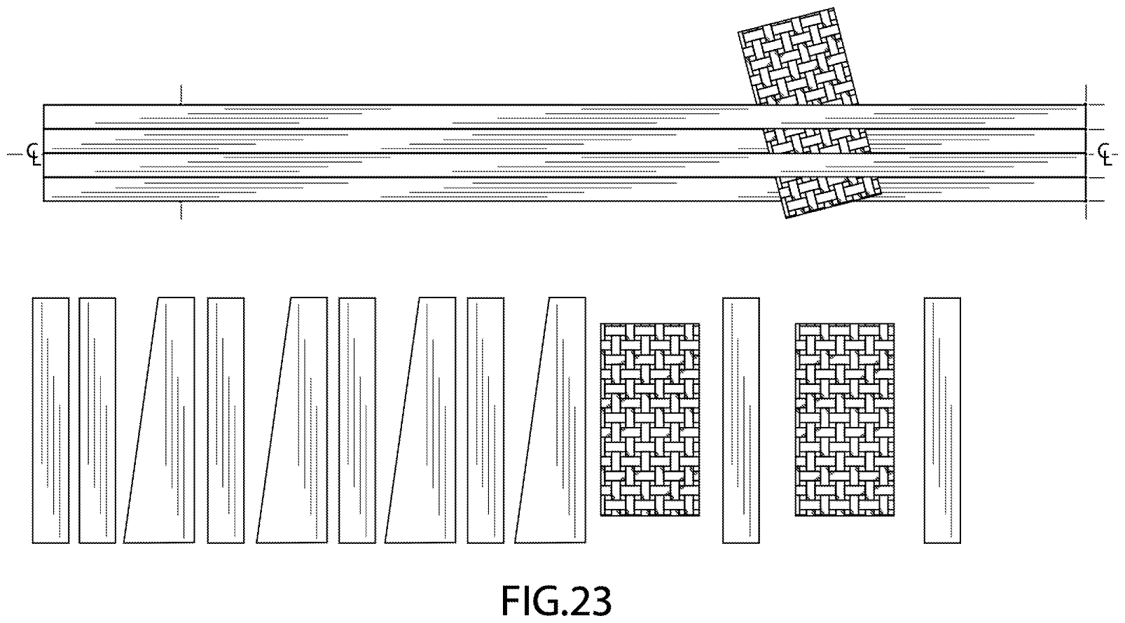

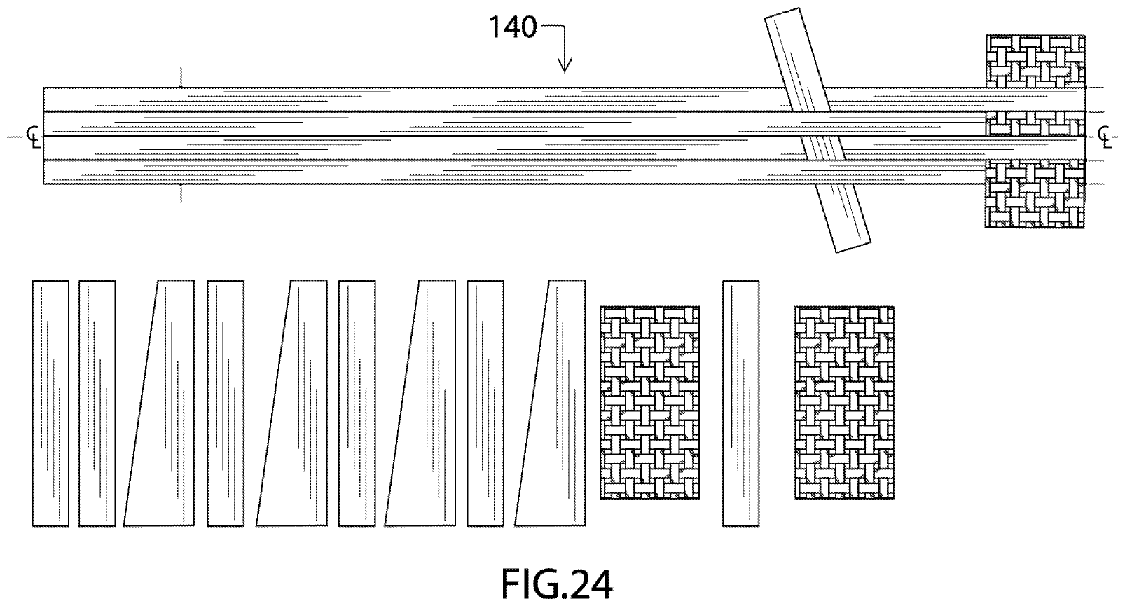

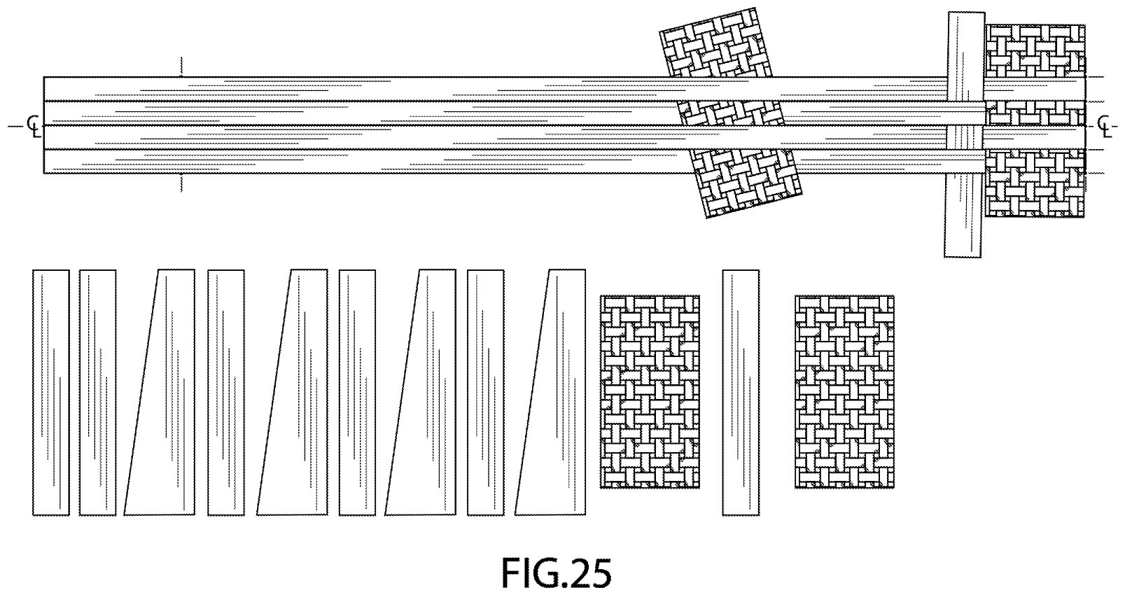

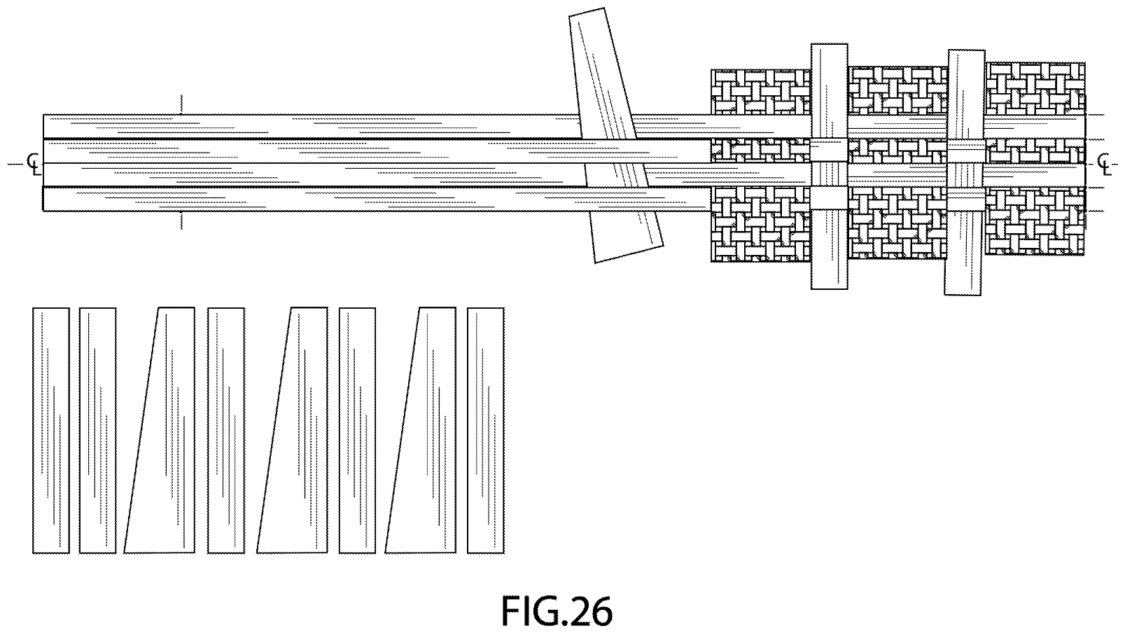

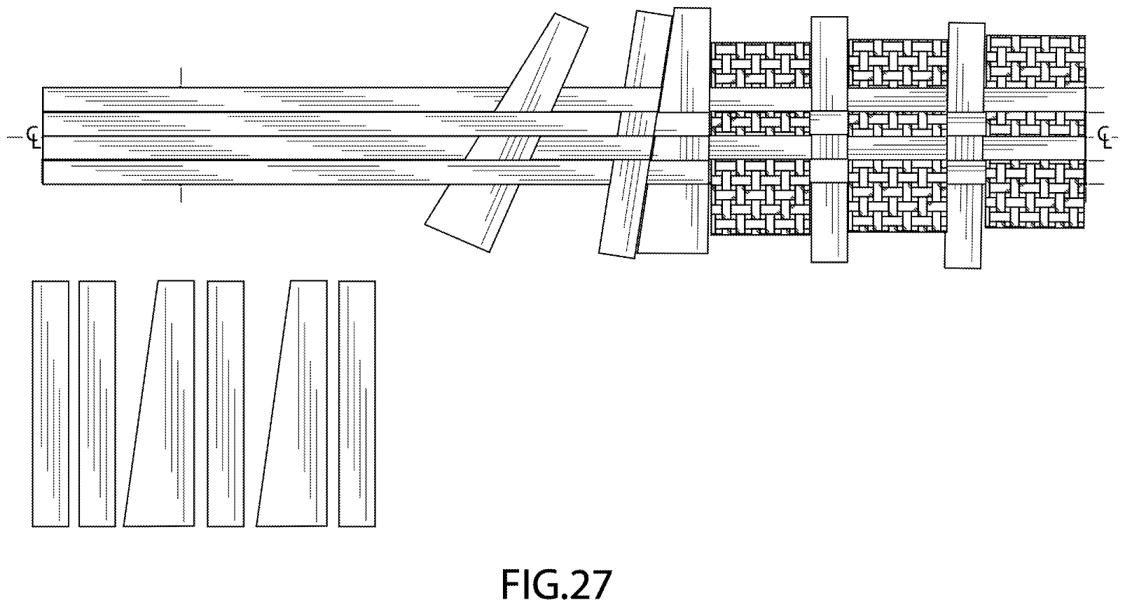

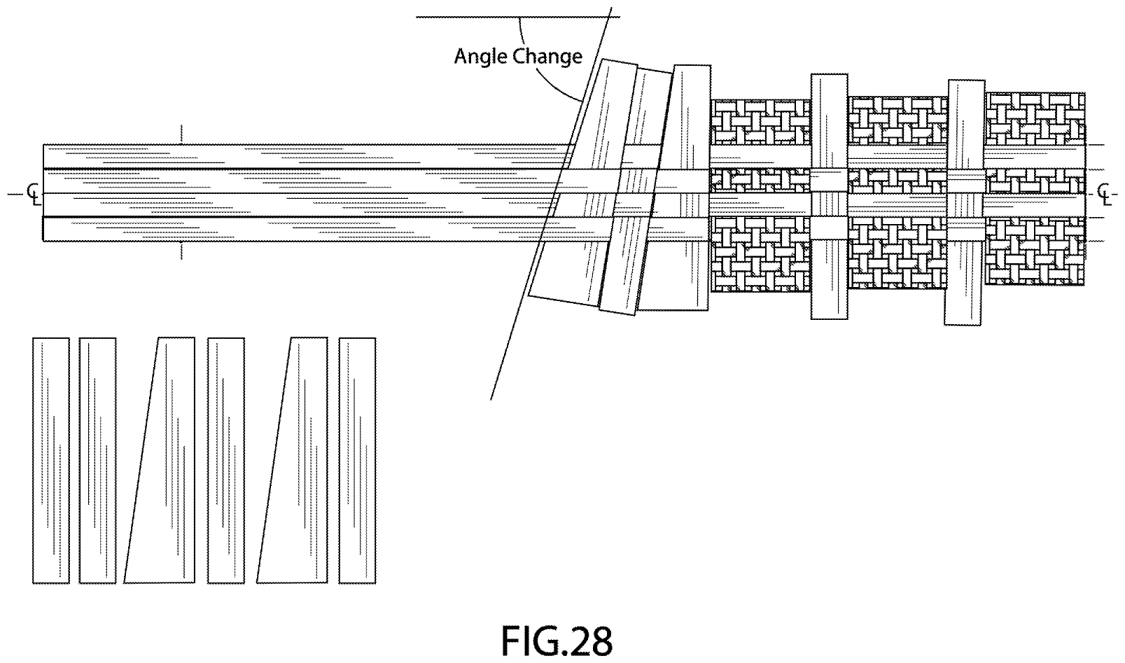

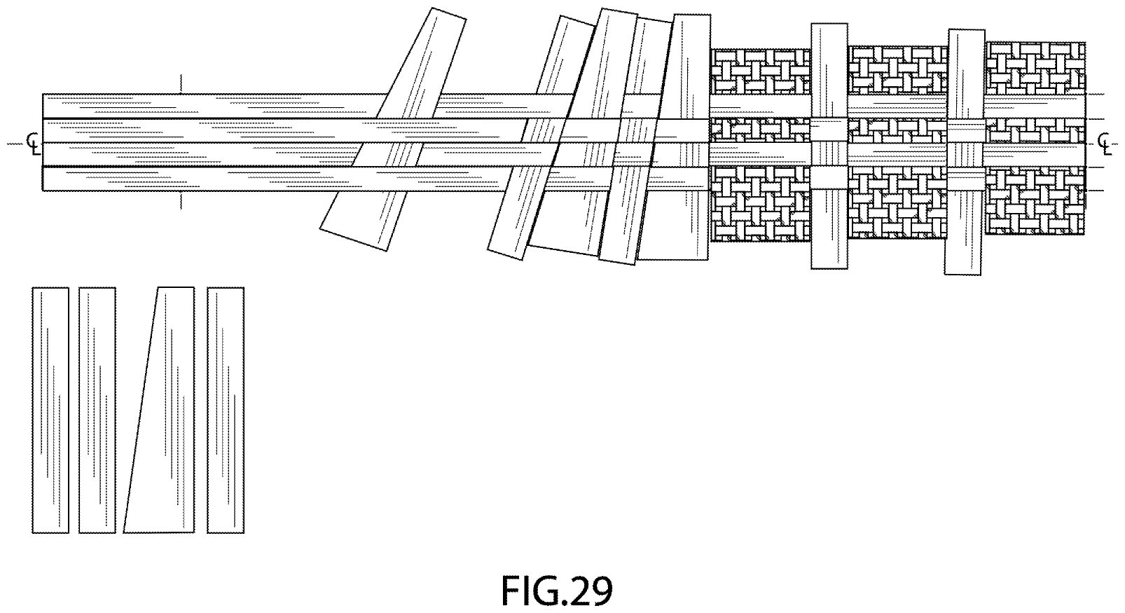

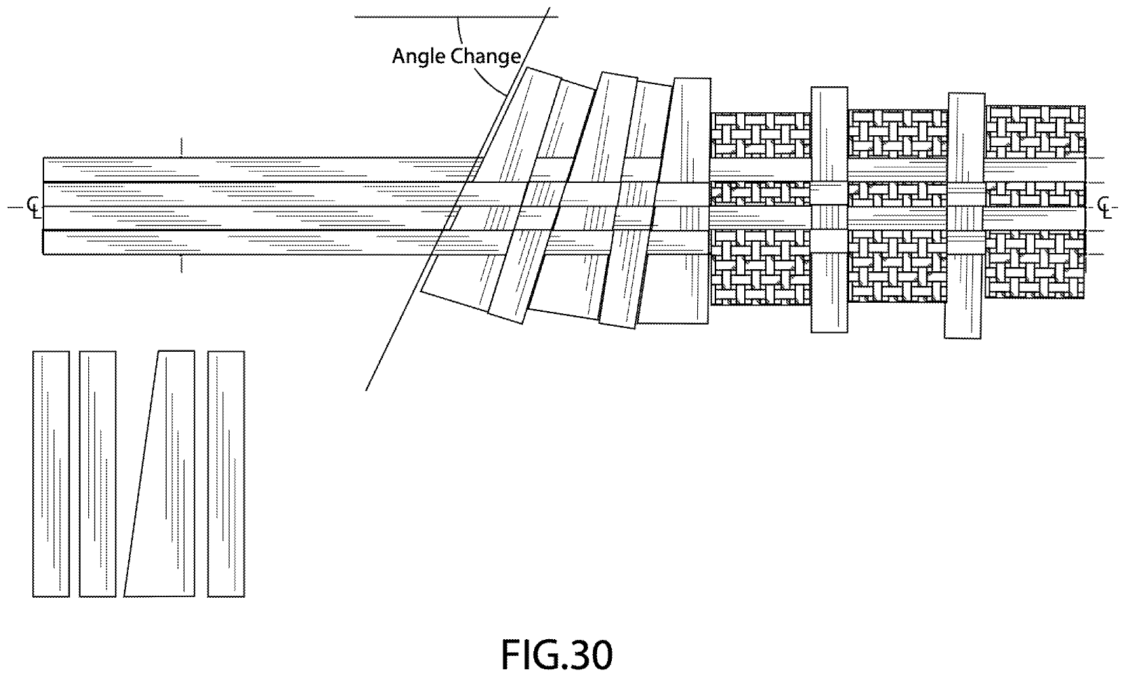

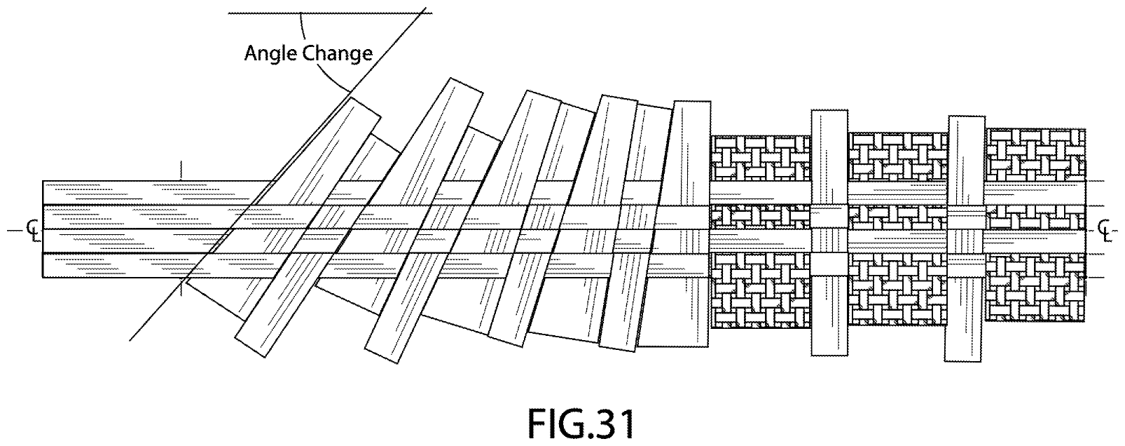

Now, reference is made to FIGS. 21-33. These figures show the sequence of manufacturing a composite woven piece to be used in a desired manner. FIG. 21 shows a plurality of elongated carbon fiber pieces designated by the reference numeral 140. A collection of woven or linear fabric pieces is collectively designated by the reference numeral 141. A flat surface 143 has drawn thereon some lines 145 and 147 which guide the user in placing the elongated carbon ribbons 140 as shown in FIG. 22. Looking at FIGS. 23-32, the fabric pieces collectively referred to in FIG. 21 by the reference numeral 141 are one-by-one assembled onto the carbon fiber ribbons 140 by weaving them in and out of the four adjacent ribbons 140. This is clearly shown, for example, in FIGS. 23-25.

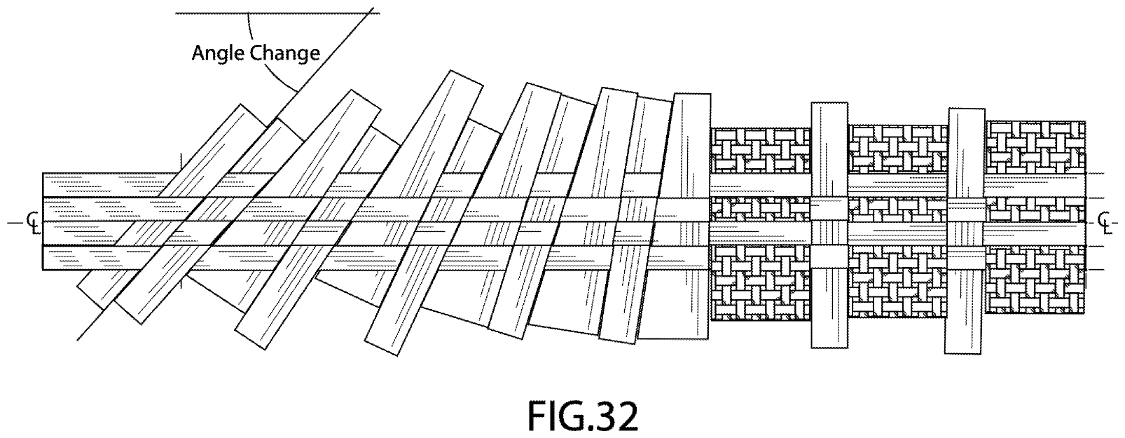

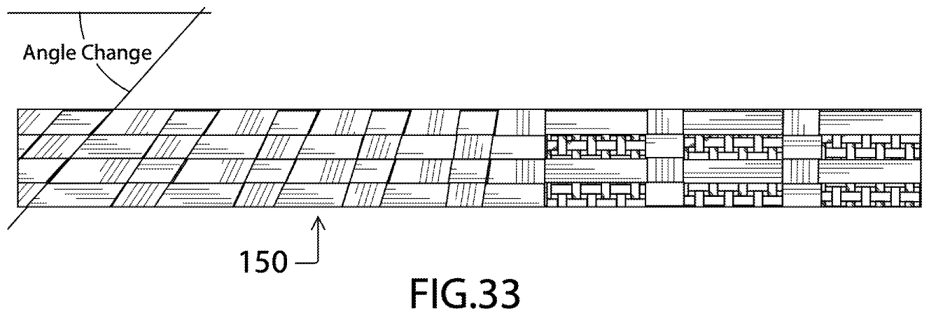

The woven fabric pieces 141 have sizes and configurations to allow variability of the stiffness of the finished composite woven piece which is designated by the reference numeral 150 in FIG. 33. As seen in the sequence of figures from FIG. 21 to FIG. 32, the fabric pieces comprising in combination the collection 141 are installed by overlapping in and out with respect to the ribbons 140 until the configuration shown in FIG. 32 is completed. Thereafter, the fabric pieces are cut along the lines 145 (FIG. 21) to form the completed composite weave 150 (FIG. 33). As can clearly be seen, there are variations in the shapes and lengths of the materials shown in the finished product 150 including use of differing materials, differing material lengths and configurations, differing shapes and differing configuration which are all intentionally provided for the purpose of being able to vary the stiffness of varying regions of the composite weave 150 without the need to have some portions thereof thicker or thinner than others. The thickness is uniform throughout.

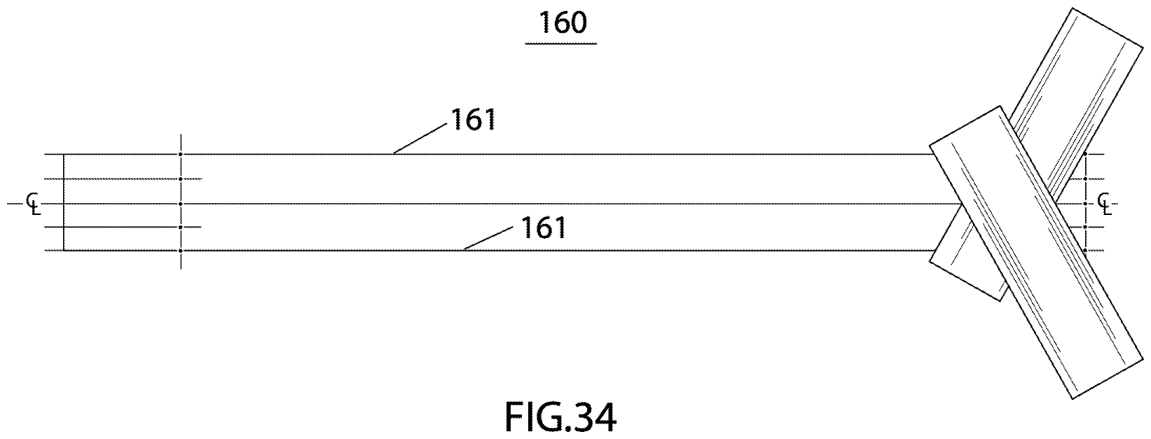

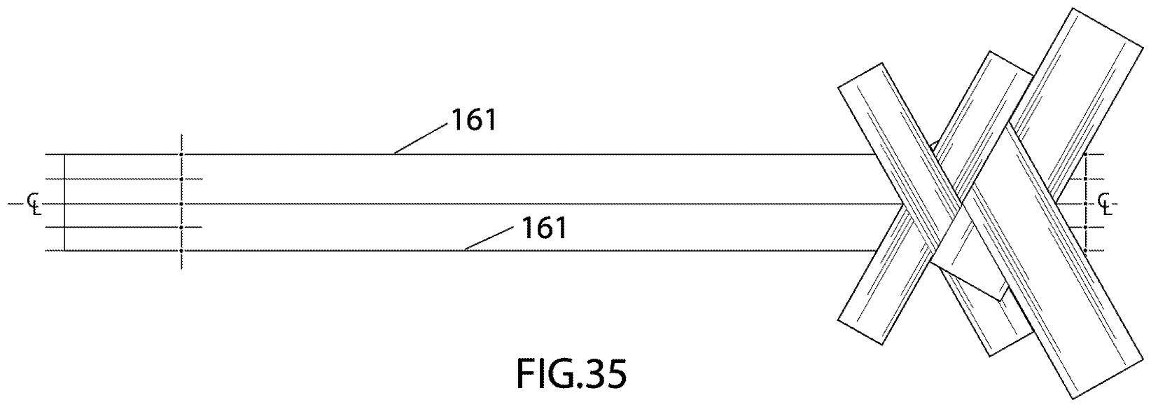

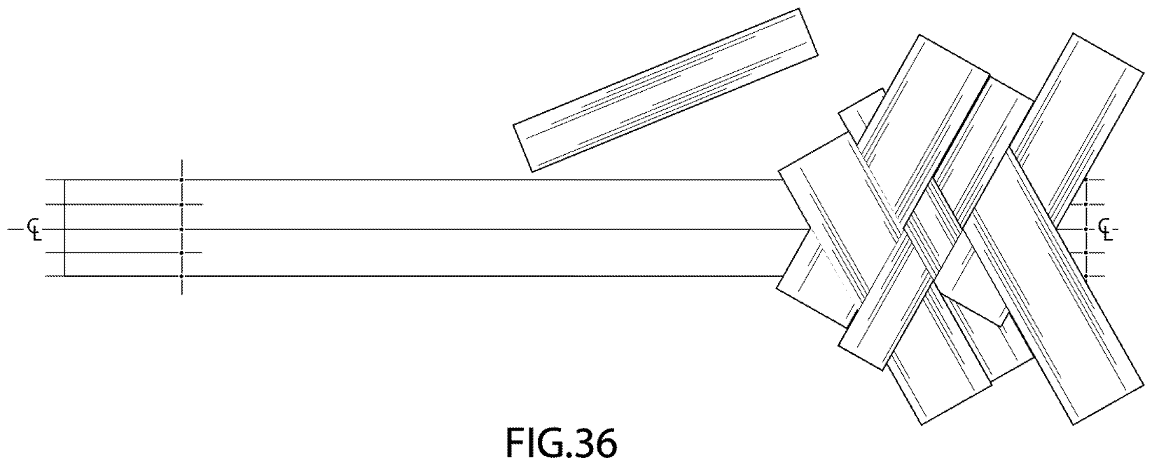

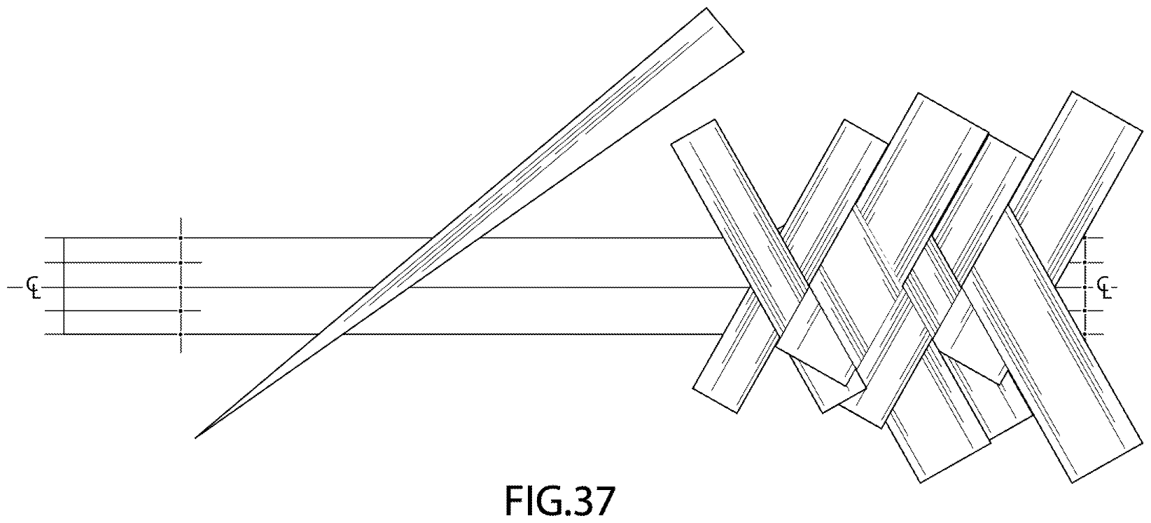

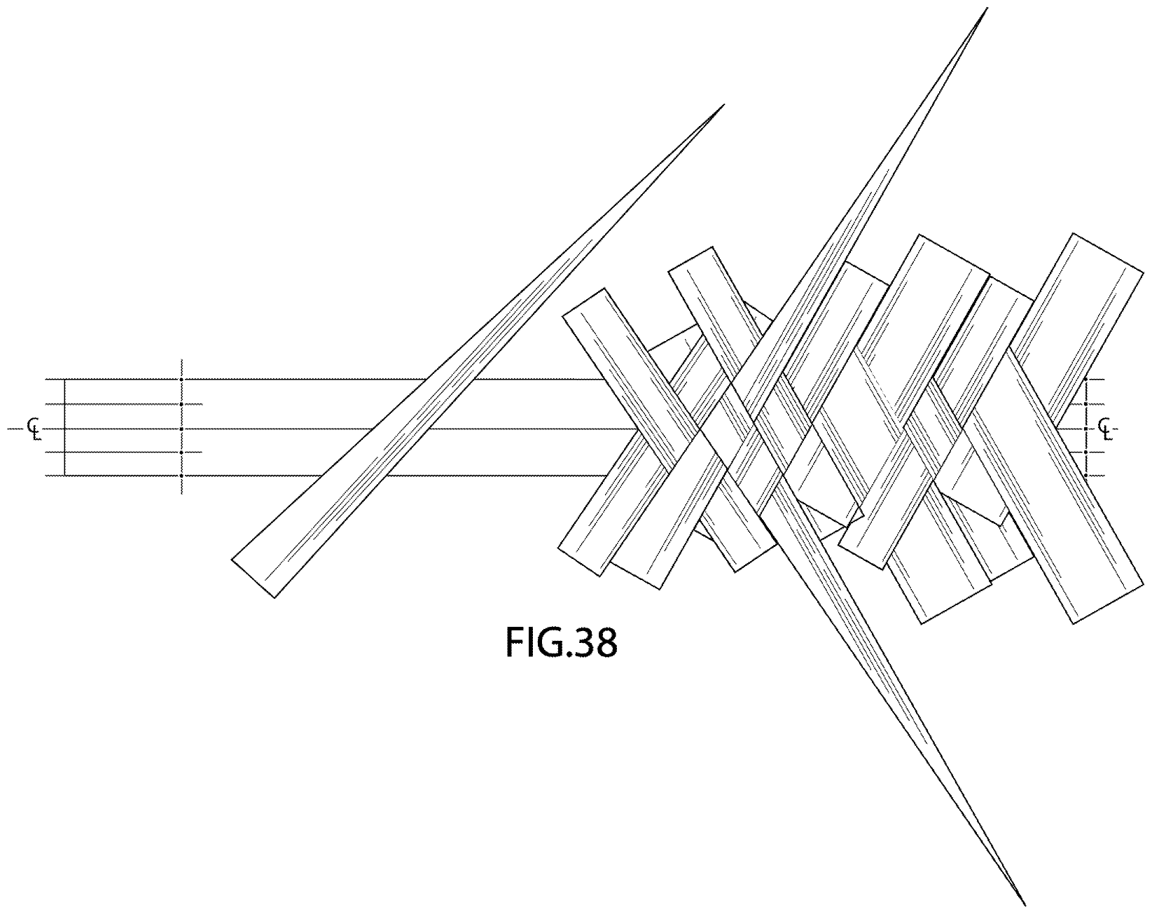

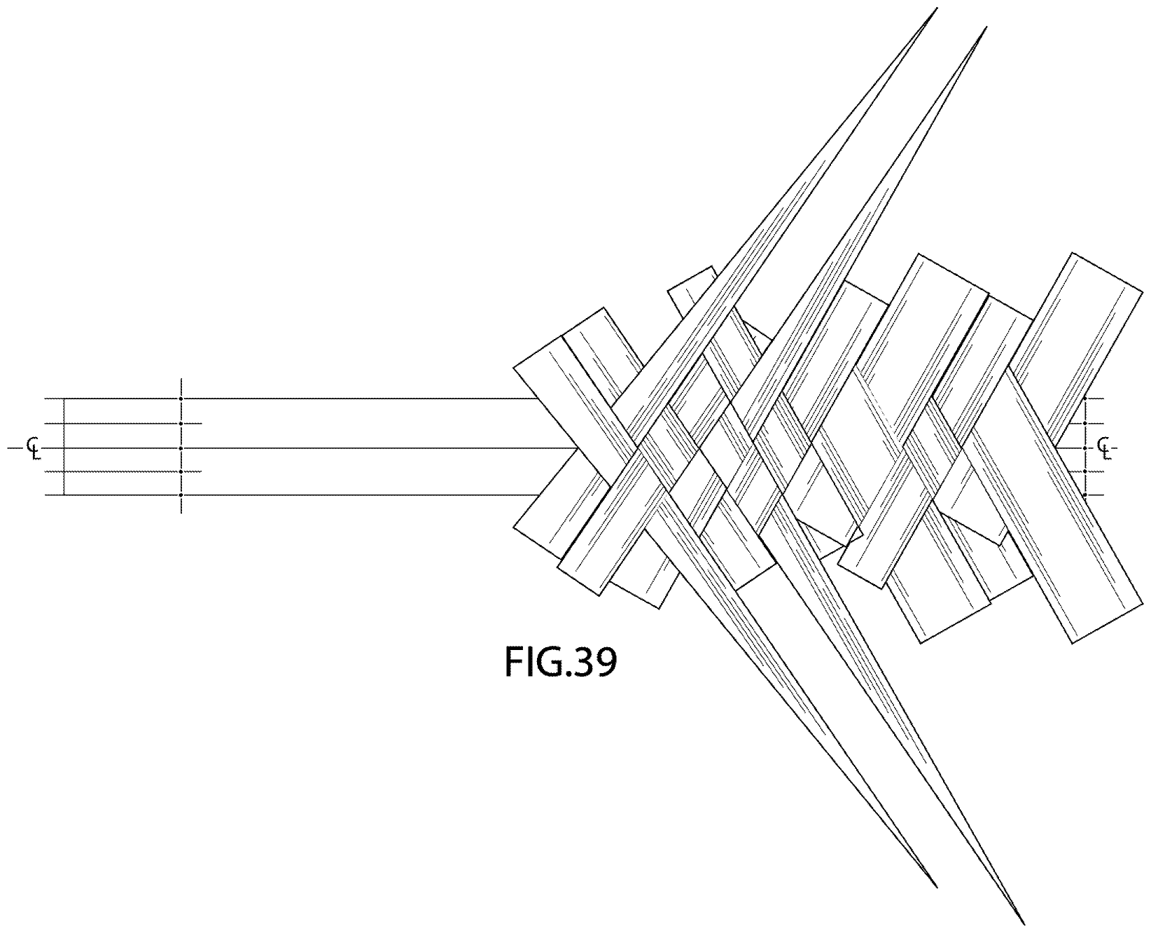

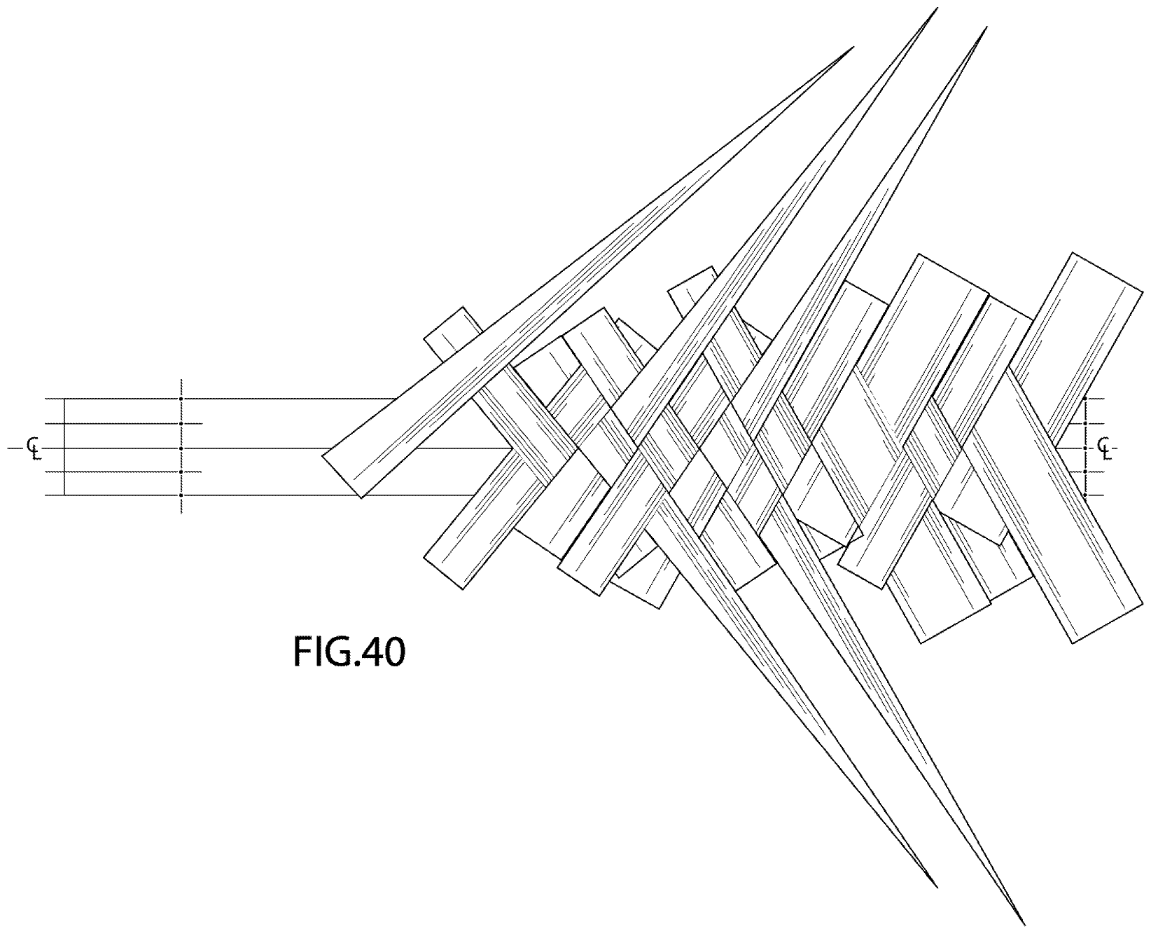

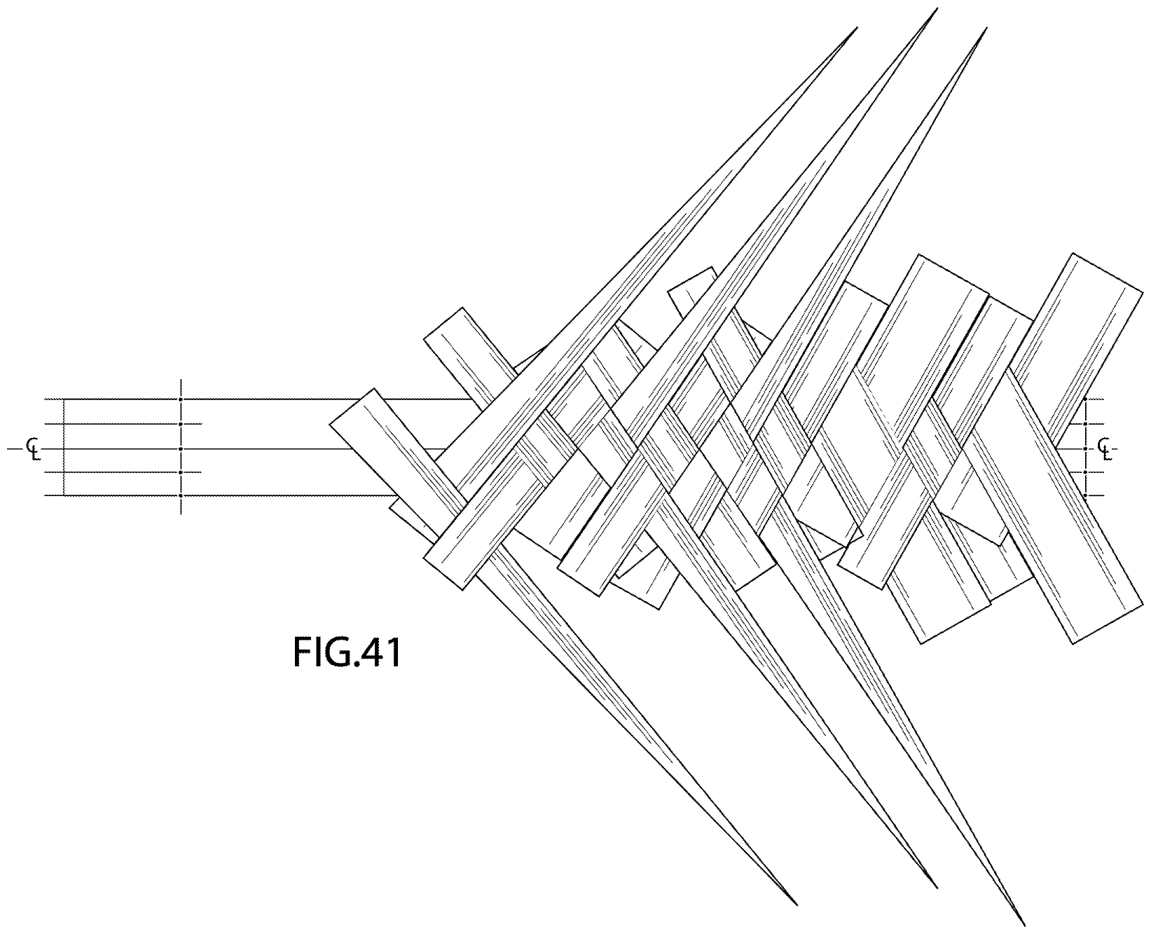

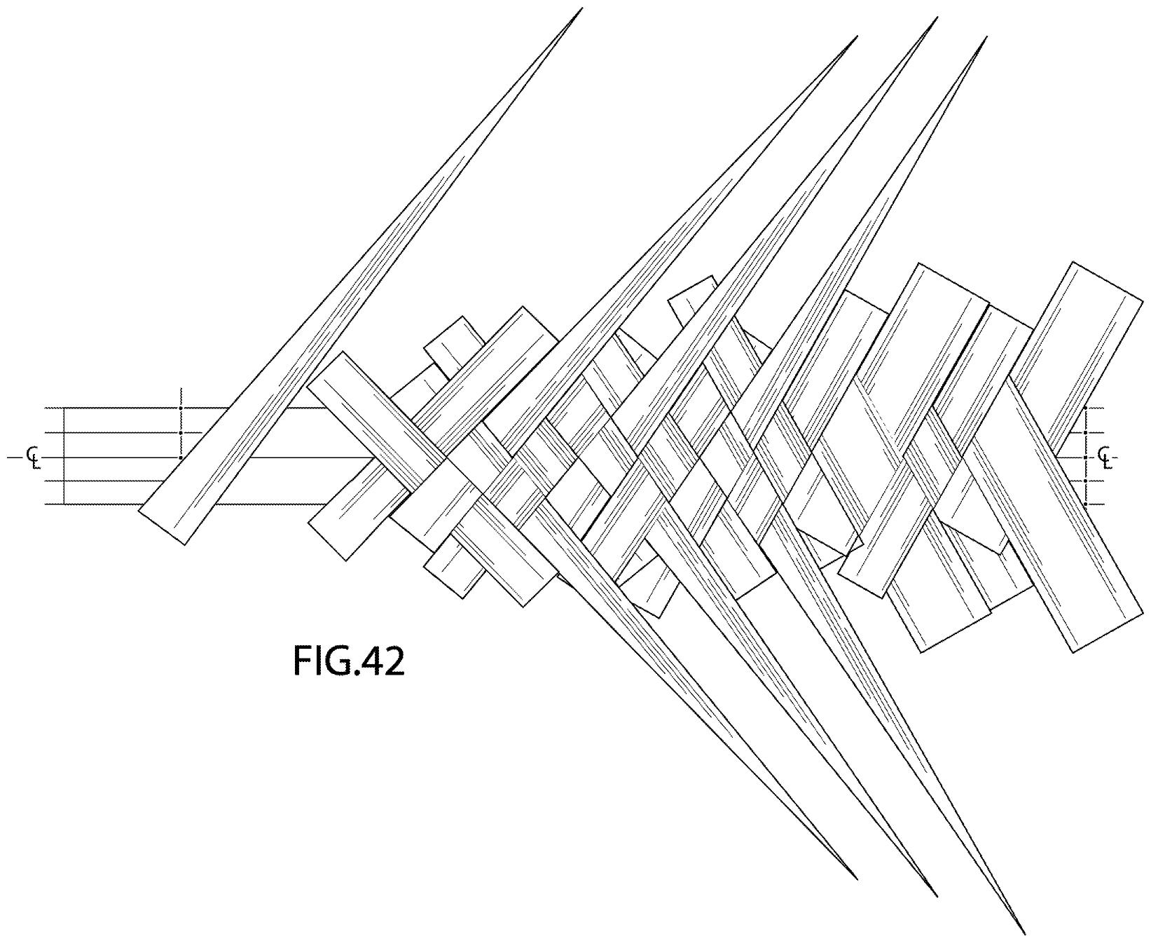

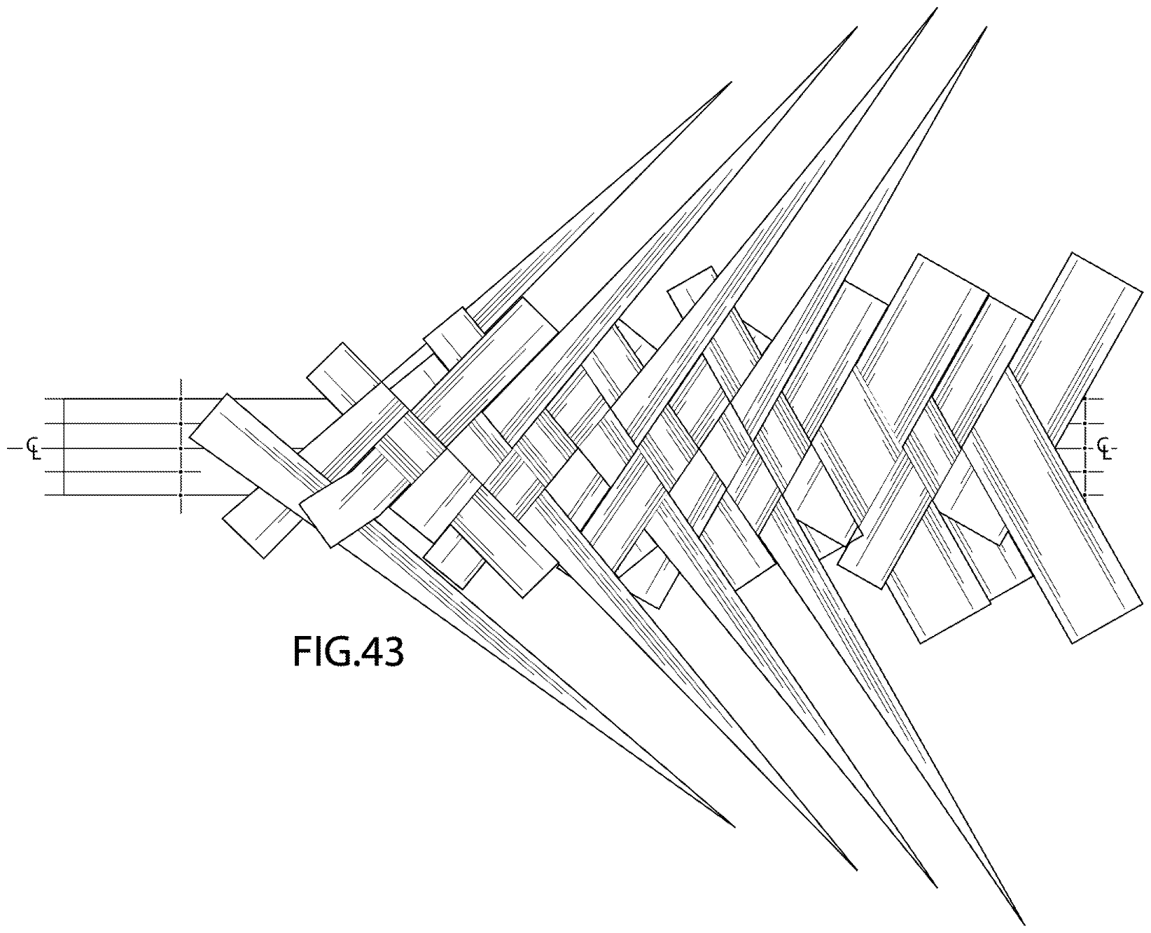

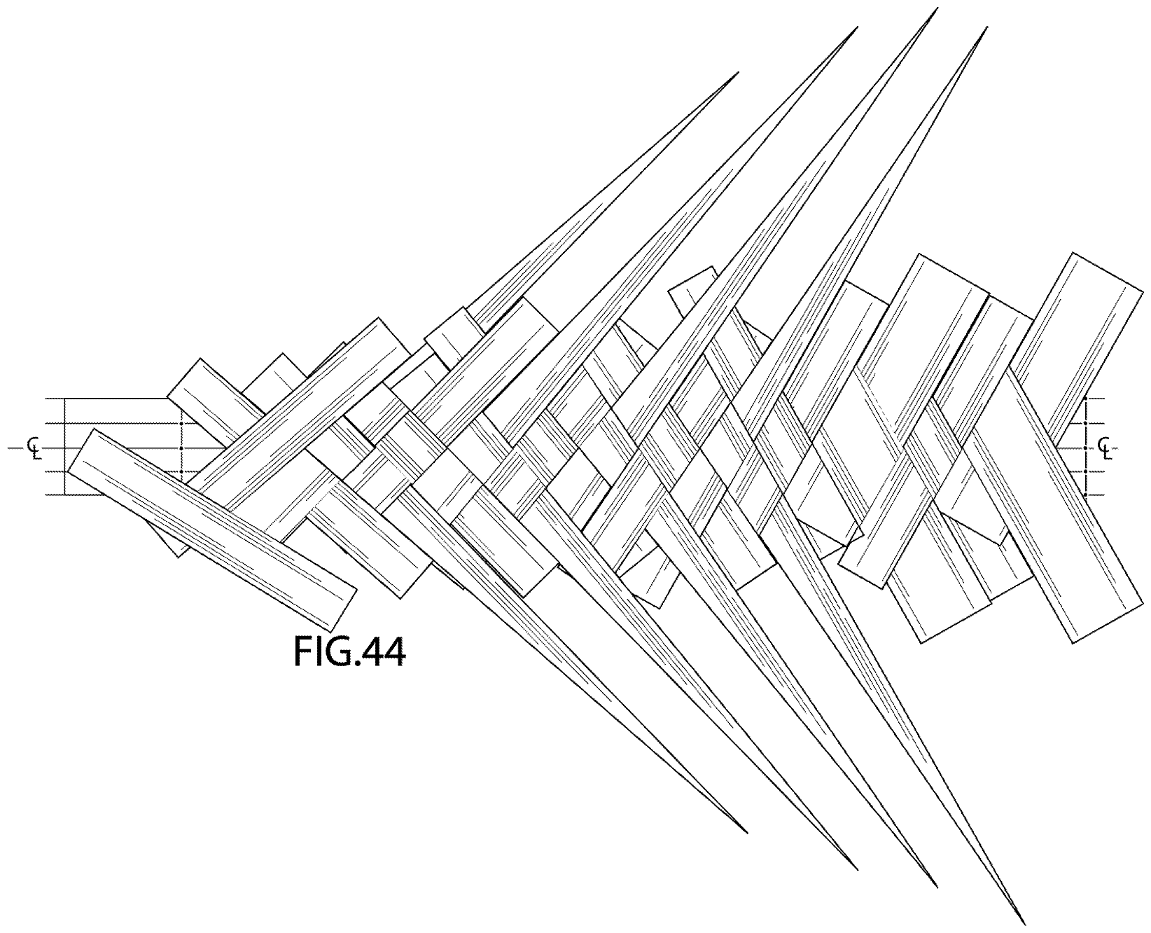

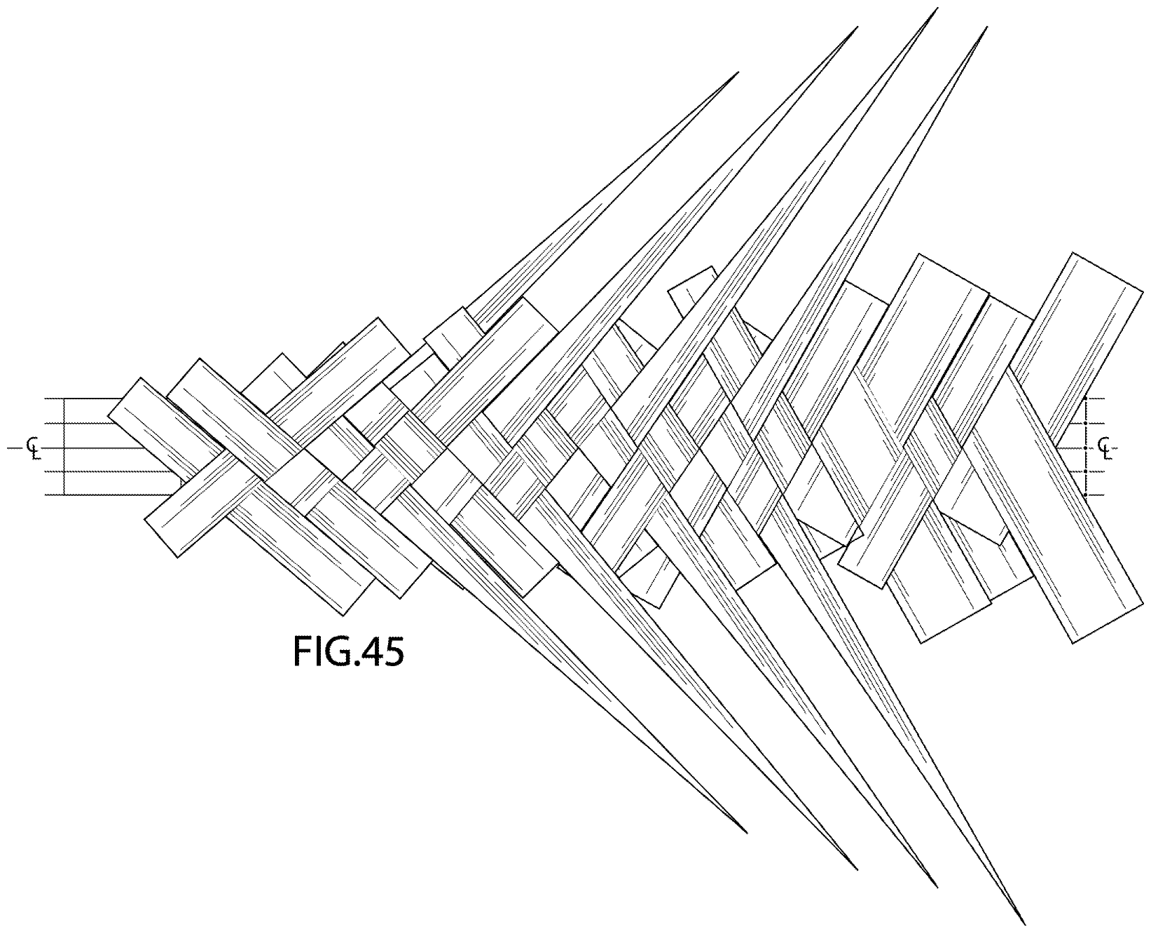

Now, with reference to FIGS. 34-46, another composite weave is shown in the manner of creating it. As shown, the reference numeral 160 comprises a flat surface on which an outline 161 is drawn to show the user where the individual woven fabric pieces are to be laid up. The individual fabric pieces are sticky in nature and, as such, can be placed and adhered over the outline formed by the lines 161 as shown in FIGS. 34-41 to create a composite weave that includes individual woven fabric pieces that are all angled with respect to the direction of elongation of the lines 161. As also seen in these figures, the fabric pieces are also made of differing materials which are selected for their various properties including, most notably, their degree of stiffness and/or flexibility.

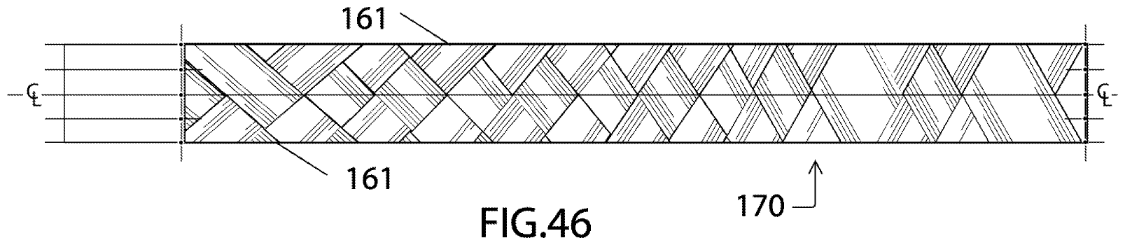

Once all of the individual fabric pieces have been laid over the rectangular area defined by the lines 161, as shown in FIG. 46, the portions of the woven fabric pieces outside the lines 161 are cut away to reveal a completed composite weave 170 that includes pre-designed characteristics which facilitate variance of the stiffness from one end to the other in a calculated manner so that the piece 170 can have variations in stiffness and flexibility while it remains of a uniform thickness from one end to the other. In the preferred embodiment of the piece 170, some of the woven fabric pieces are unidirectional fiberglass while others are unidirectional carbon fiber.

With the above description of the preferred embodiments in mind, it is important to stress that as amply explained above, the main purposes of the present invention are to provide a composite weave that has uniformity of thickness throughout its length and creates areas of greater and lesser stiffness in adjusting the lengths of individual woven fabric pieces as well as the angulation of their fibers with respect to the direction of extension of the composite fabric piece without the need to have areas of greater or lesser thickness. The composite weave is then processed to create a finished product.

As such, an invention has been disclosed in terms of preferred embodiments thereof which fulfill each and every one of the objects of the invention as set forth hereinabove, and provide new and useful methods of asymmetrically weaving raw fiber materials to create fiber reinforced products and products created thereby of great novelty and utility.

Of course, various changes, modifications and alterations in the teachings of the present invention may be contemplated by those skilled in the art without departing from the intended spirit and scope thereof.

As such, it is intended that the present invention only be limited by the terms of the appended claims.

1. A method of creating a composite weave made up of fiber reinforced materials to be processed to be incorporated into a finished product after processing, the finished product exhibiting desired properties, including the steps of:
a) determining desired properties of a finished product, said properties comprising a plurality of properties chosen from the group consisting of flexibility, stiffness and strength;
b) choosing fiber reinforced materials exhibiting properties that, when processed, will result in creation of said finished product;
c) providing a multiplicity of individual weaves, each individual weave being made of a chosen material exhibiting one or more of said chosen properties;
d) connecting said individual weaves together to form a composite weave having an axis of elongation, each individual weave having specifications as to length along said axis of elongation and angulation of fibers with respect to said axis of elongation, at least one of said individual weaves having a differing length or angulation of its fibers as compared to another of said individual weaves, said composite weave comprising a single ply;
e) whereby said composite weave is processed to create said finished product.

2. The method of claim 1, wherein at least one of said individual weaves has fibers angled with respect to said axis of elongation.

3. The method of claim 1, wherein a first individual weave has a first length, and a second individual weave has a second differing length.

4. The method of claim 1, wherein said connecting step comprises providing a plurality of adjacent elongated ribbons and weaving said individual weaves to said ribbons.

5. The method of claim 4, wherein said plurality of ribbons comprises four ribbons.

6. The method of claim 4, wherein said ribbons are made of carbon fiber.

7. The method of claim 1, wherein said chosen material is chosen from the group consisting of a fiber weave of carbon, Aramid fibers, and glass.

8. The method of claim 1, wherein said angulation is within a range of 27.5° to 47.5°.

9. The method of claim 1, wherein said connecting step comprises providing a surface, adhering said individual weaves to said surface in a desired configuration and cutting a periphery of said individual weaves to form said composite weave.

10. The method of claim 1, wherein some of said individual weaves are stiffer than others of said individual weaves.

11. The method of claim 10, wherein some of said individual weaves have fibers angled with respect to said axis of elongation at an angle different from an angle of fibers of others of said individual weaves.

12. The method of claim 10, wherein some of said individual weaves are longer than others of said individual weaves.

13. The method of claim 1, wherein some of said individual weaves are rectangular.

14. The method of claim 1, wherein some of said individual weaves are diamond shaped.

15. The method of claim 13, wherein some of said individual weaves are diamond shaped.

16. The method of claim 10, wherein some of said individual weaves are longer than others of said individual weaves.

17. A method of creating a composite weave made up of fiber reinforced materials to be processed to be incorporated into a finished product after processing, said finished product exhibiting desired properties, including the steps of:
a) determining desired properties of a finished product, said properties comprising a plurality of properties chosen from the group consisting of flexibility, stiffness and strength;
b) choosing fiber reinforced materials exhibiting properties that, when processed, will result in creation of said finished product;
c) providing a multiplicity of individual weaves, each individual weave being made of a chosen material exhibiting one or more of said chosen properties, said chosen material being chosen from the group consisting of a fiber weave of carbon, Aramid fibers, and glass;
d) connecting said individual weaves together to form a composite weave having an axis of elongation, each individual weave having specifications as to length along said axis of elongation and angulation of fibers with respect to said axis of elongation, at least one of said individual weaves having a differing length or angulation of its fibers as compared to another of said individual weaves, said composite weave comprising a single ply;
e) some of said individual weaves being rectangular and others of said individual weaves being diamond shaped;
f) whereby said composite weave is processed to create said finished product.

18. The method of claim 17, wherein a first individual weave has a first length, and a second individual weave has a second differing length.

19. The method of claim 17, wherein said connecting step comprises providing a plurality of adjacent elongated carbon fiber ribbons and weaving said individual weaves to said ribbons.

20. The method of claim 17, wherein said angulation is within a range of 27.5° to 47.5°.
